(19) United States
(12) Patent Application Publication
(10) Pub. No.: US 2019/0173140 A1
(43) Pub. Date: Jun. 6, 2019

(54) TEMPERATURE CONDITIONING UNIT, TEMPERATURE CONDITIONING SYSTEM, AND VEHICLE

(71) Applicant: Panasonic Intellectual Property Management Co., Ltd., Osaka (JP)

(72) Inventors: SHIZUKA YOKOTE, Osaka (JP); TAKASHI OGAWA, Osaka (JP); YUICHI YOSHIKAWA, Osaka (JP); MICHIHIRO KUROKAWA, Osaka (JP)

(21) Appl. No.: 16/321,847

(22) PCT Filed: Jun. 23, 2017
(86) PCT No.: PCT/JP2017/023117

§ 371 Date: Jan. 30, 2019

(30) Foreign Application Priority Data
Aug. 29, 2016 (JP) 2016-167030
Aug. 29, 2016 (JP) 2016-167031

(51) Int. Cl. H01M 10/6563; B60H 1/14; H01M 10/613; H01M 10/625; H01M 10/63; F04D 29/66; F04D 17/16; F04D 25/16; F04D 29/30

(52) U.S. Cl. CPC H01M 10/6563; B60H 1/143; H01M 10/613; H01M 10/625; B60H 2001/006; F04D 29/661; F04D 17/16; F04D 25/166; F04D 29/30; H01M 10/63

(57) ABSTRACT

Temperature conditioning unit (100X) includes first intake and exhaust device (10A), second intake and exhaust device (20A), and housing (30) that accommodates element (50) to temperature-condition. First intake and exhaust device (10A) and second intake and exhaust device (20A) each include: a rotary drive device including a shaft and a rotary drive source that rotates the shaft; an impeller including an impeller disk that engages the shaft at its central part and includes a surface extending in a direction intersecting the shaft, and a plurality of rotor vanes erected on the impeller disk; and a fan case including a side wall surrounding the impeller, an intake port, and a vent communicating with an interior of housing (30). The plurality of rotor vanes each extend in a direction from the central part to an outer peripheral part of the impeller disk in the shape of a circular arc bulging in a rotation direction of the shaft. A frequency at which first intake and exhaust device (10A) produces a sound having an energy peak is different from a frequency at which second intake and exhaust device (20A) produces a sound having an energy peak.

### TECHNICAL FIELD

The present invention relates to a temperature conditioning unit, a temperature conditioning system, and a vehicle mounted with the temperature conditioning unit or the temperature conditioning system. The present invention relates more particularly to reduction of noise from the temperature conditioning unit.

### BACKGROUND ART

Power storage devices that include a secondary battery and power converters that include an inverter and a converter (hereinafter collectively referred to as elements to temperature-condition) each produce heat because of internal resistance and external resistance during passage of electric current. When a temperature of the element to temperature-condition is too high, the element to temperature-condition does not fully exhibit its performance. Even when used at too low an ambient temperature, for example, in a cold region, the element to temperature-condition does not fully exhibit its performance. In other words, the temperature of the element to temperature-condition greatly affects an output characteristic or a power conversion characteristic of the element to temperature-condition and a life of the element to temperature-condition.

Those elements to temperature-condition can be mounted, for example, in a hybrid vehicle or an electric vehicle (EV). To ensure an internal cabin space of the vehicle, the element to temperature-condition is mounted in a limited area. As such, a plurality of battery cells that form the secondary battery are closely mounted in a housing that accommodates these battery cells, and their heat is hard to dissipate. Similarly, the power converter is placed in an environment where its heat is hard to dissipate. Moreover, the hybrid vehicle and the EV, for example, are required to be used in a wide temperature range. Even the element to temperature-condition mounted in these vehicles is required to operate in the wide temperature range.

In PTL 1, an intake and exhaust device (blower) forcibly feeds gas into a housing that accommodates an element to temperature-condition, thereby adjusting an interior of the housing to a temperature that is suitable for output of the secondary battery or operation of the power converter. Recently, higher output and smaller size are required of the secondary battery that is mounted in the hybrid vehicle. Accordingly, heat dissipation or heating of the secondary battery and the power converter is an increasingly important challenge.

To further dissipation of heat from the element to temperature-condition or to further heating of the element to temperature-condition, combined use of a plurality of intake and exhaust devices is conceivable. However, the combined use of the plurality of intake and exhaust devices can cause production of a considerably loud sound (noise) from these intake and exhaust devices.

### CITATION LIST

### Patent Literature

PTL 1: Unexamined Japanese Patent Publication No. 2010-080134

### SUMMARY OF THE INVENTION

In one aspect, a temperature conditioning unit according to the present invention includes a first intake and exhaust device, a second intake and exhaust device, and a housing that accommodates an element to temperature-condition. The first intake and exhaust device and the second intake and exhaust device each include: a rotary drive device including a shaft and a rotary drive source that rotates the shaft; an impeller including an impeller disk that engages the shaft at its central part and includes a surface extending in a direction intersecting the shaft, and a plurality of rotor vanes erected on the impeller disk; and a fan case including a side wall surrounding the impeller, an intake port, and a vent communicating with an interior of the housing. The plurality of rotor vanes each extend in a direction from the central part to an outer peripheral part of the impeller disk in the shape of a circular arc bulging in a rotation direction of the shaft. A frequency at which the first intake and exhaust device produces a sound having an energy peak is different from a frequency at which the second intake and exhaust device produces a sound having an energy peak.

In one aspect, a temperature conditioning system according to the present invention includes a temperature conditioning unit, an intake duct connecting with respective intake ports of a first intake and exhaust device and a second intake and exhaust device, a plurality of supply ducts that supply gas to the intake duct, and a system controller that selects one or more from among the plurality of supply ducts to effect supply of the gas to the intake duct.

In another aspect, a temperature conditioning system according to the present invention includes a first temperature conditioning unit, a second temperature conditioning unit, a first intake duct connecting with respective intake ports of a first intake and exhaust device and a second intake and exhaust device of the first temperature conditioning unit, a first exhaust duct that lets gas out from an outlet of the first temperature conditioning unit, a second intake duct connecting with respective intake ports of a first intake and exhaust device and a second intake and exhaust device of the second temperature conditioning unit, a second exhaust duct that lets gas out from an outlet of the second temperature conditioning unit, and a circulation controller that selects at least one of the first exhaust duct and the second exhaust duct to effect supply of the gas to at least one of the first intake duct and the second intake duct.

In yet another aspect, a temperature conditioning system according to the present invention includes a first temperature conditioning unit, a second temperature conditioning unit, a first intake duct connecting with respective intake ports of a first intake and exhaust device and a second intake and exhaust device of the first temperature conditioning unit, a second intake duct connecting with respective intake ports of a first intake and exhaust device and a second intake and exhaust device of the second temperature conditioning unit, a connection duct branching off and connecting with the first intake duct and the second intake duct, and a flow rate controller that controls a flow rate of gas in the first intake duct and a flow rate of gas in the second intake duct.

In one aspect, a vehicle according to the present invention is mounted with a temperature conditioning unit.

In another aspect, a vehicle according to the present invention is mounted with a temperature conditioning system.

According to the present invention, a noise is produced in suppressed condition by the temperature conditioning unit including the plurality of intake and exhaust devices.

### BRIEF DESCRIPTION OF DRAWINGS

FIG. 1A is a perspective view schematically illustrating a temperature conditioning unit according to a first exemplary embodiment.

FIG. 1B is a sectional view of the temperature conditioning unit, the section being taken on plane 1B-1B of FIG. 1A.

FIG. 2A is a perspective view of a first intake and exhaust device of the temperature conditioning unit according to the first exemplary embodiment.

FIG. 2B is a longitudinal section of the first intake and exhaust device of the temperature conditioning unit according to the first exemplary embodiment.

FIG. 3A is a perspective view of an impeller that is disposed in the first intake and exhaust device of the temperature conditioning unit according to the first exemplary embodiment.

FIG. 3B is a top plan view of first rotor vanes that are disposed in the first intake and exhaust device of the temperature conditioning unit according to the first exemplary embodiment.

FIG. 3C is a perspective view of an impeller that is disposed in a second intake and exhaust device of the temperature conditioning unit according to the first exemplary embodiment.

FIG. 3D is a top plan view of second rotor vanes that are disposed in the second intake and exhaust device of the temperature conditioning unit according to the first exemplary embodiment.

FIG. 4 is a graph showing a relationship between rotational order and energy of blade passing frequency (BPF) noise produced by the first and second intake and exhaust devices of the temperature conditioning unit of the first exemplary embodiment.

FIG. 5 illustrates a gas flow effected by each of the first rotor vanes disposed in the first intake and exhaust device of the temperature conditioning unit of the first exemplary embodiment.

FIG. 6 illustrates a gas flow effected by each of forward swept vanes disposed in the first intake and exhaust device of the temperature conditioning unit of the first exemplary embodiment.

FIG. 7 is a graph showing respective gas volume-pressure relationships of the gas flows that are respectively effected by the first rotor vane disposed in the first intake and exhaust device of the temperature conditioning unit of the first exemplary embodiment and the forward swept vane disposed in the first intake and exhaust device of the temperature conditioning unit of the first exemplary embodiment.

FIG. 8 is a graph showing a specific speed-fan efficiency relationship of the first intake and exhaust device using the first rotor vanes in the temperature conditioning unit of the first exemplary embodiment and a specific speed-fan efficiency relationship of the first intake and exhaust device using the forward swept vanes in the temperature conditioning unit of the first exemplary embodiment.

FIG. 9 is a graph showing a flow coefficient-pressure coefficient relationship of the first intake and exhaust device using the first rotor vanes in the temperature conditioning unit of the first exemplary embodiment and a flow coefficient-pressure coefficient relationship of the first intake and exhaust device using the forward swept vanes in the temperature conditioning unit of the first exemplary embodiment.

FIG. 10 is a block diagram illustrating a first temperature conditioning system according to the first exemplary embodiment.

FIG. 11 is a block diagram illustrating a second temperature conditioning system according to the first exemplary embodiment.

FIG. 12 is a block diagram illustrating a third temperature conditioning system according to the first exemplary embodiment.

FIG. 13A is a schematic view of a vehicle according to the first exemplary embodiment.

FIG. 13B is a schematic view of another vehicle according to the first exemplary embodiment.

FIG. 14A is a longitudinal section of a first intake and exhaust device according to a second exemplary embodiment.

FIG. 14B is a longitudinal section of a second intake and exhaust device according to the second exemplary embodiment.

FIG. 15 is a sectional perspective view of a first intake and exhaust device according to a third exemplary embodiment.

FIG. 16 is a perspective view illustrating an impeller and stator vanes according to the third exemplary embodiment.

FIG. 17A is a perspective view schematically illustrating a temperature conditioning unit according to a fourth exemplary embodiment.

FIG. 17B is a sectional view of the temperature conditioning unit, the section being taken on plane 17B-17B of FIG. 17A.

FIG. 18A is a perspective view schematically illustrating a temperature conditioning unit according to a fifth exemplary embodiment.

FIG. 18B is a sectional view of the temperature conditioning unit, the section being taken on plane 18B-18B of FIG. 18A.

FIG. 19A is a perspective view of a third intake and exhaust device of the temperature conditioning unit according to the fifth exemplary embodiment.

FIG. 19B is a longitudinal section of the third intake and exhaust device of the temperature conditioning unit according to the fifth exemplary embodiment.

FIG. 20A is a perspective view of an impeller that is disposed in the third intake and exhaust device of the temperature conditioning unit according to the fifth exemplary embodiment.

FIG. 20B is a top plan view of third rotor vanes that are disposed in the third intake and exhaust device of the temperature conditioning unit according to the fifth exemplary embodiment.

FIG. 20C is a perspective view of an impeller that is disposed in a fourth intake and exhaust device of the temperature conditioning unit according to the fifth exemplary embodiment.

FIG. 20D is a top plan view of fourth rotor vanes that are disposed in the fourth intake and exhaust device of the temperature conditioning unit according to the fifth exemplary embodiment.

FIG. 21 is a graph showing a relationship between rotational order and energy of BPF noise produced by the third and fourth intake and exhaust devices of the temperature conditioning unit of the fifth exemplary embodiment.

FIG. 22 is a sectional view of the third intake and exhaust device in the temperature conditioning unit of the fifth exemplary embodiment, as viewed from an intake port.

FIG. 23 is a block diagram illustrating a fourth temperature conditioning system according to the fifth exemplary embodiment.

FIG. 24 is a block diagram illustrating a fifth temperature conditioning system according to the fifth exemplary embodiment.

FIG. 25 is a block diagram illustrating a sixth temperature conditioning system according to the fifth exemplary embodiment.

FIG. 26A is a schematic view of a vehicle according to the fifth exemplary embodiment.

FIG. 26B is a schematic view of another vehicle according to the fifth exemplary embodiment.

FIG. 27A is a longitudinal section of a third intake and exhaust device according to a sixth exemplary embodiment.

FIG. 27B is a longitudinal section of a fourth intake and exhaust device according to the sixth exemplary embodiment.

FIG. 28A is a perspective view schematically illustrating a temperature conditioning unit according to a seventh exemplary embodiment.

FIG. 28B is a sectional view of the temperature conditioning unit, the section being taken on plane 28B-28B of FIG. 28A.

### DESCRIPTION OF EMBODIMENTS

An aerodynamic sound caused by rotor vanes is cited as a typical noise produced by an intake and exhaust device. The aerodynamic sound is also referred to as BPF noise or discrete frequency noise. Frequency Fb (Hz) at which BPF noise energy peaks is calculated by Formula 1 below.

Fb=m×r/60×N Formula 1

In Formula 1, m is an integer greater than or equal to 1, r is rotational speed (rpm) of an impeller, and N is a number of rotor vanes.

Pressure (static pressure) and volume of gas that is supplied or discharged by the intake and exhaust device affect efficiency of cooling an element to temperature-condition. As such, in cases where a plurality of intake and exhaust devices are disposed for a housing, the intake and exhaust devices generally have impellers of the same type and are driven with their impellers having common rotational speed r. In this way, the intake and exhaust devices respectively supply or discharge gases that are comparable in pressure and volume. Accordingly, the element to temperature-condition is uniformly cooled or heated. In such cases, respective BPF noise frequencies Fb of the intake and exhaust devices that are calculated by Formula 1 are the same. This means that the intake and exhaust devices have coincident BPF noise energy peaks. As a consequence, a noise produced is at a maximum level. It is to be noted that a BPF noise generally has the highest energy peak at the lowest frequency Fb (i.e., when m=1) that is calculated by Formula 1.

In exemplary embodiments of the present invention, in cases where intake and exhaust devices to dispose for a housing are greater than or equal to two in number, frequency Fb at which at least one of those intake and exhaust devices produces a sound (BPF noise) having peak energy is made different from frequency Fb at which another intake and exhaust device produces a BPF noise having peak energy. In this way, BPF noise peaks are dispersed when the plurality of intake and exhaust devices are used.

As shown in Formula 1, frequency Fb at which a BPF noise has peak energy varies based on number N of rotor vanes and rotational speed r of the rotor vanes. A description is hereinafter provided of the first exemplary embodiment in which two intake and exhaust devices with different numbers N of rotor vanes are used, the second exemplary embodiment in which two intake and exhaust devices with different rotational speeds r are used, and modifications of these exemplary embodiments (the third exemplary embodiment).

### First Exemplary Embodiment

A temperature conditioning unit according to the present exemplary embodiment includes a first intake and exhaust device, a second intake and exhaust device, and a housing that accommodates an element to temperature-condition. The first intake and exhaust device and the second intake and exhaust device have different numbers of rotor vanes.

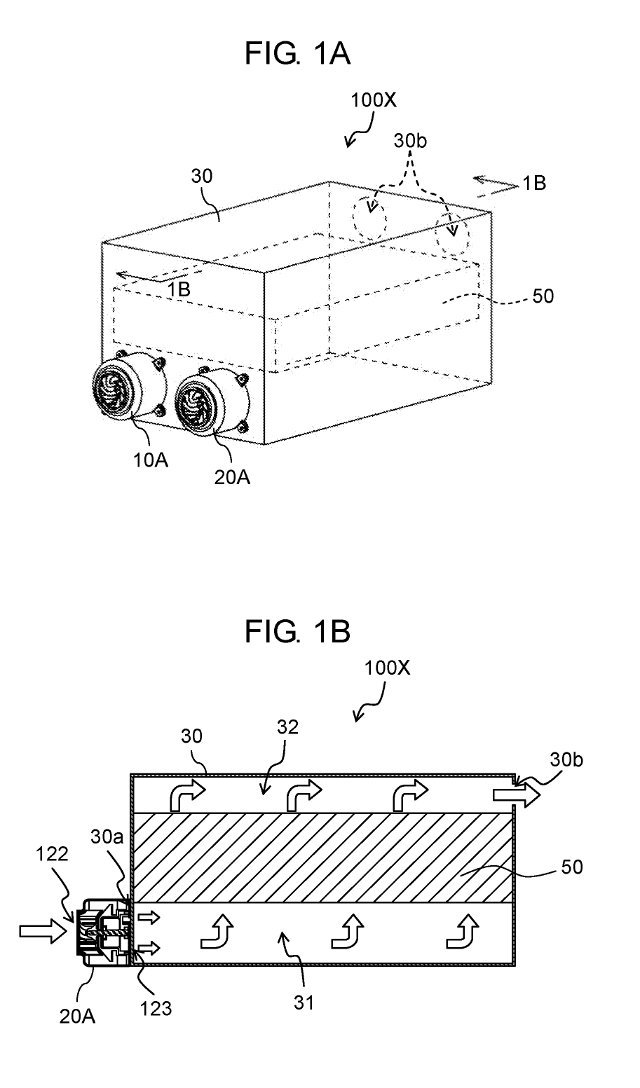

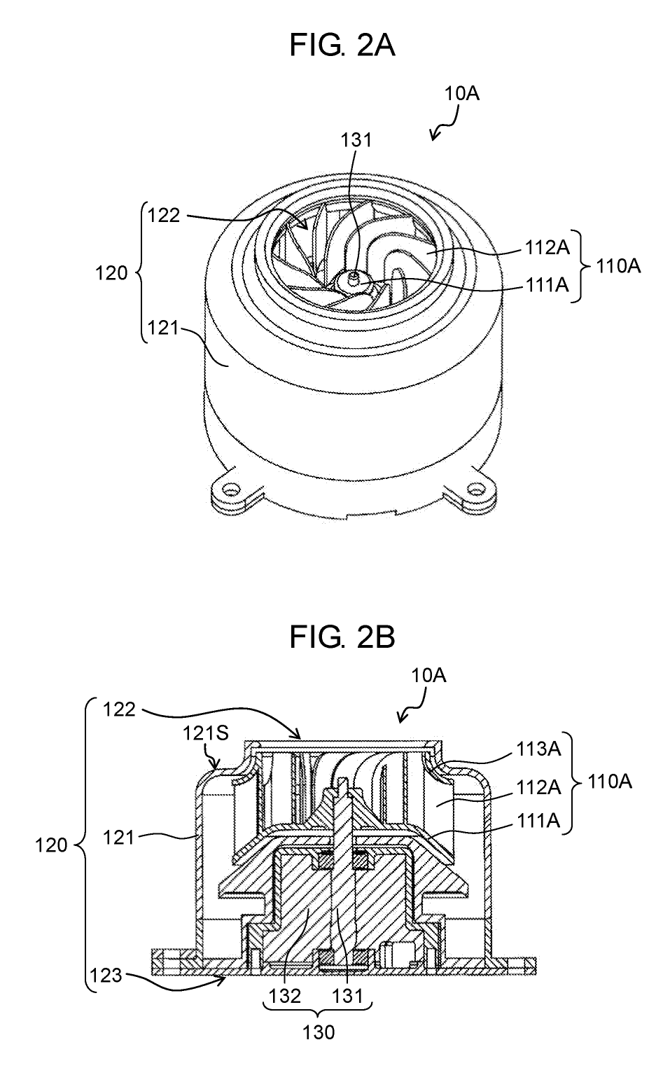

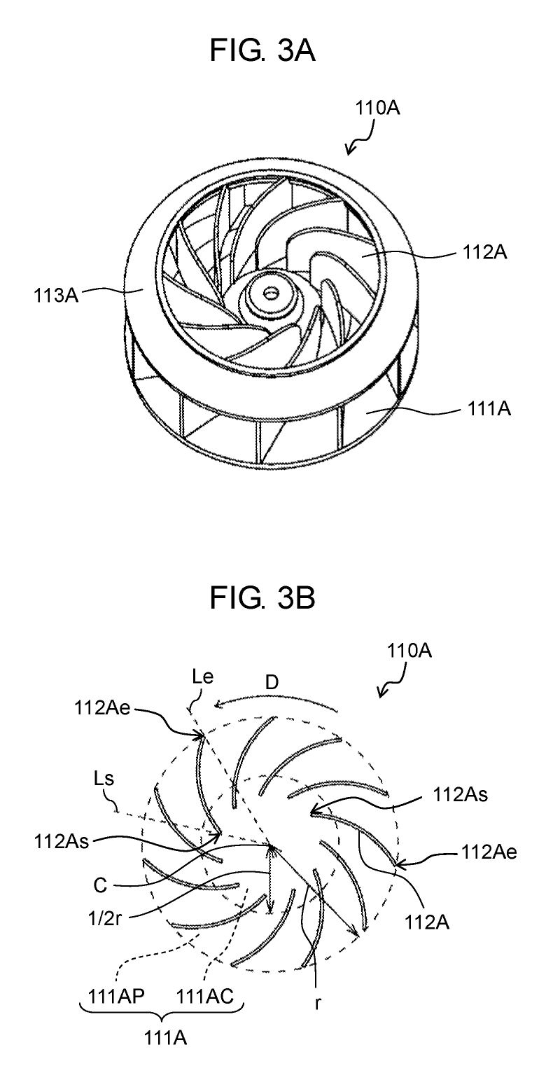

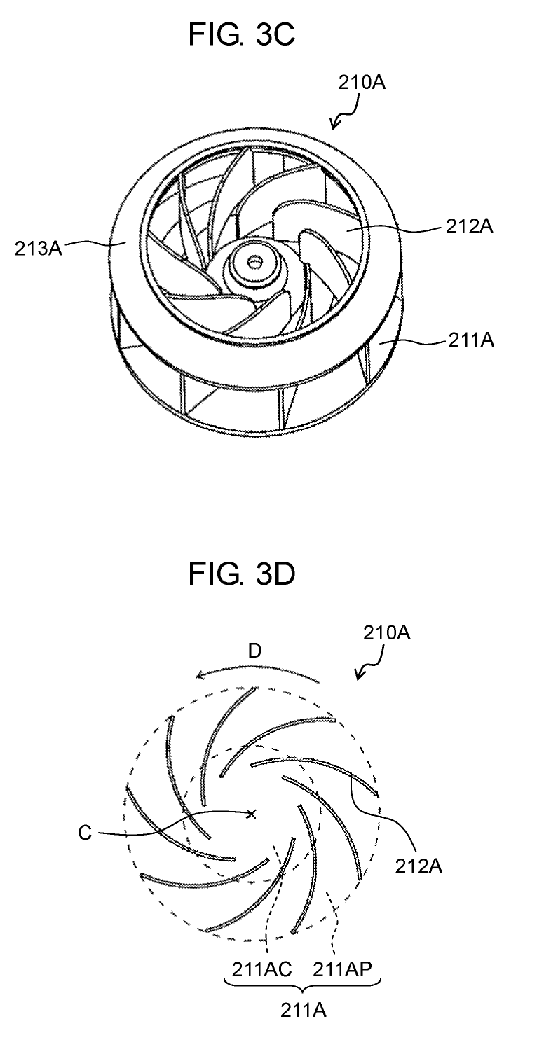

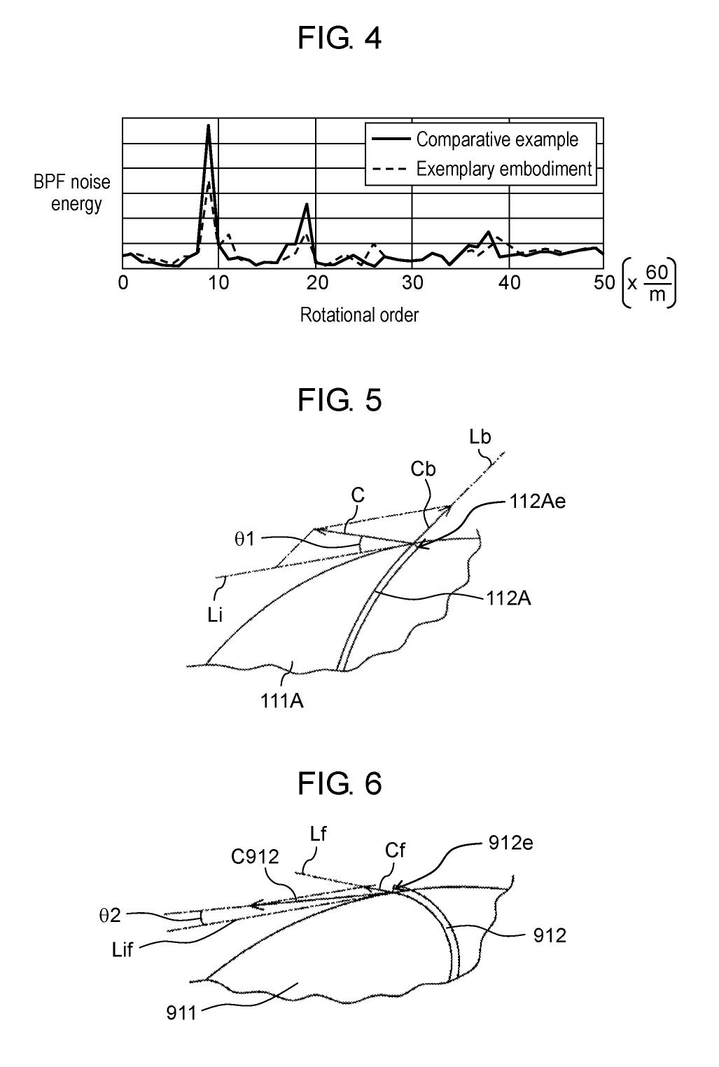

With reference to FIGS. 1A to 4, a specific description is hereinafter provided of temperature conditioning unit 100X according to the first exemplary embodiment. FIG. 1A is a perspective view schematically illustrating temperature conditioning unit 100X according to the first exemplary embodiment. FIG. 1B is a sectional view of temperature conditioning unit 100X, the section being taken on plane 1B-1B of FIG. 1A. FIG. 2A is a perspective view of first intake and exhaust device 10A of temperature conditioning unit 100X according to the first exemplary embodiment. FIG. 2B is a longitudinal section of first intake and exhaust device 10A of temperature conditioning unit 100X in the first exemplary embodiment. FIG. 3A is a perspective view of impeller 110A that is disposed in first intake and exhaust device 10A of temperature conditioning unit 100X according to the first exemplary embodiment. FIG. 3B is a top plan view of first rotor vanes 112A that are disposed in first intake and exhaust device 10A of temperature conditioning unit 100X according to the first exemplary embodiment. FIG. 3C is a perspective view of impeller 210A that is disposed in second intake and exhaust device 20A of temperature conditioning unit 100X according to the first exemplary embodiment. FIG. 3D is a top plan view of second rotor vanes 212A of temperature conditioning unit 100X according to the first exemplary embodiment. In FIGS. 3B and 3D, shrouds 113A, 213A are omitted. In FIGS. 3B and 3D, impeller disks 111A, 211A are indicated by broken lines. FIG. 4 is a graph showing a relationship between rotational order and energy of BPF noise produced by first and second intake and exhaust devices 10A and 20A of temperature conditioning unit 100X of the first exemplary embodiment. In the drawings, members having identical functions have the same reference marks.

### (Temperature Conditioning Unit)

As illustrated in FIGS. 1A and 1B, temperature conditioning unit 100X includes first intake and exhaust device 10A, second intake and exhaust device 20A, and housing 30. Housing 30 accommodates element 50 to temperature-condition. Housing 30 is provided with at least one inlet 30a where external gas is taken in and at least one outlet 30b where the gas is discharged out of housing 30.

First intake and exhaust device 10A and second intake and exhaust device 20A are mounted such that their respective vents 123 face inlets 30a, respectively. This means that first intake and exhaust device 10A and second intake and exhaust device 20A function as blowers in the present exemplary embodiment. Inlets 30a communicate with external space, an exhaust duct (described later), or an intake duct (described later) via respective first and second intake and exhaust devices 10A and 20A. Also outlets 30b communicate with the external space, the exhaust duct (described later), or the intake duct (described later). Thus, the gas flows into housing 30 through first intake and exhaust device 10A and second intake and exhaust device 20A.

As illustrated in FIG. 1B, element 50 to temperature-condition is disposed to divide an interior of housing 30 into intake-side chamber 31 including inlets 30a and exhaust-side chamber 32 including outlets 30b. The gas forcibly fed through inlets 30a by first intake and exhaust device 10A and second intake and exhaust device 20A diffuses throughout intake-side chamber 31, passes through gaps in element 50 to temperature-condition or between element 50 to temperature-condition and housing 30 and then flows into exhaust-side chamber 32. That is when element 50 is temperature-conditioned, namely, cooled or heated. The gas that has flowed into exhaust-side chamber 32 is discharged into the external space through outlets 30b. Here the flow of gas is indicated as an example by outlined arrows.

Intake-side chamber 31 and exhaust-side chamber 32 may be equal or different in capacity. Above all, intake-side chamber 31 preferably has a larger capacity than exhaust-side chamber 32. Intake-side chamber 31 generally has a higher internal pressure than exhaust-side chamber 32. With the capacity of intake-side chamber 31 being larger, intake-side chamber 31 has decreased pressure resistance, thus having uniform pressure distribution. Consequently, the gas spreads throughout element 50 to temperature-condition without nonuniformity, whereby element 50 is entirely temperature-conditioned, namely, cooled or heated with efficiency.

Temperature conditioning unit 100X may have one outlet 30b or outlets 30b that are greater than or equal to two in number. A number of intake and exhaust devices to dispose in temperature conditioning unit 100X is not particularly limited as long as the number of intake and exhaust devices is greater than or equal to 2. Also disposition of element 50 to temperature-condition is not particularly limited. Element 50 to temperature-condition may be suitably disposed based on, for example, a use or its kind.

### (Intake and Exhaust Devices)

First intake and exhaust device 10A is given as an example to describe structure of first intake and exhaust device 10A and structure of second intake and exhaust device 20A. Except for the difference in the number of rotor vanes, first intake and exhaust device 10A and second intake and exhaust device 20A may be structurally similar. Alternatively, in addition to the difference in the number of rotor vanes, there may be another structural difference (for example, a difference in impeller disk size) between first intake and exhaust device 10A and second intake and exhaust device 20A.

As shown in FIGS. 2A and 2B, first intake and exhaust device 10A includes impeller 110A, fan case 120, and rotary drive device 130. Impeller 110A includes impeller disk 111A and the plurality of first rotor vanes 112A. Fan case 120 includes side wall 121, intake port 122, and vent 123. Rotary drive device 130 includes shaft 131 and rotary drive source 132 that rotates shaft 131.

### (Impeller)

Impeller 110A includes impeller disk 111A and the plurality of first rotor vanes 112A. Impeller 110A may also include shroud 113A.

### (Impeller Disk)

Impeller disk 111A is substantially circular and has a surface extending in a direction intersecting shaft 131 (preferably, perpendicularly to shaft 131). The plurality of first rotor vanes 112A are erected on one of principal surfaces of impeller disk 111A. Impeller disk 111A has an opening in a part of its central part 111AC (refer to FIG. 3B). Shaft 131 is inserted into this opening to engage impeller disk 111A. Rotary drive source 132 is rotationally driven, whereby impeller 110A rotates. As illustrated in FIG. 2B, outer peripheral part 111AP (refer to FIG. 3B) of impeller disk 111A may be partly bent toward vent 123. In this way, the gas taken into first intake and exhaust device 10A flows smoothly toward vent 123.

### (Shroud)

Shroud 113A is formed of a ring-shaped plate and is disposed to face impeller disk 111A via first rotor vanes 112A. When impeller 110A is viewed in an axial direction of shaft 131, an outer peripheral edge of impeller disk 111A is substantially aligned with an outer peripheral edge of shroud 113A. Here outer peripheral part 111AP of impeller disk 111A is partly covered by shroud 113A. Each of first rotor vanes 112A is partly joined to shroud 113A. The gas taken into impeller 110A flows along first rotor vanes 112A, flows out from the outer peripheral edge of impeller disk 111A and then collides against side wall 121, thereby being guided to vent 123. Shroud 113A suppresses outflow of the gas that has flowed out from the outer peripheral edge of impeller disk 111A from intake port 122. Shroud 113A suppresses entry of the gas that has flowed out of an inter-vane passage formed by two adjacent first rotor vanes 112A into an adjacent inter-vane passage. To suppress a turbulent flow of gas, shroud 113A is preferably funnel-shaped or tapered having a gently curved surface that narrows toward intake port 122.

### (Rotor Vanes)

The plurality of first rotor vanes 112A are erected on the one of the principal surfaces of impeller disk 111A. As illustrated in FIG. 3B, first rotor vanes 112A each extend in a direction from central part 111AC to outer peripheral part 111AP of impeller disk 111A in the shape of a circular arc bulging in rotation direction D of shaft 131.

Similarly, the plurality of second rotor vanes 212A disposed in second intake and exhaust device 20A each extend, as illustrated in FIGS. 3C and 3D, in a direction from central part 211AC to outer peripheral part 211AP of impeller disk 211A in the shape of a circular arc bulging in rotation direction D. Impeller 210A of second intake and exhaust device 20A is structurally similar to impeller 110A. Impeller 210A may also include shroud 213A.

Here number N1 of first rotor vanes 112A and number N2 of second rotor vanes 212A satisfy Relational Expression 1 and Relational Expression 2.

N1≠N2×n1 (where n1 is an integer greater than or equal to 1) Relational Expression 1

N1≠N2/n2 (where n2 is an integer greater than or equal to 2) Relational Expression 2

In other words, number N1 of first rotor vanes 112A is different from number N2 of second rotor vanes 212A, and number N1 is neither an integral multiple of number N2 nor a value obtained by division of number N2 by the integer. Accordingly, BPF noise frequency Fb1 of first intake and exhaust device 10A does not coincide with BPF noise frequency Fb2 of second intake and exhaust device 20A, irrespective of integer m. In this way, BPF noises are dispersed in terms of energy, and a noise is produced in suppressed condition by temperature conditioning unit 100X.

FIG. 4 is a graph showing a relationship between rotational order and energy of BPF noise produced by first and second intake and exhaust devices 10A and 20A of temperature conditioning unit 100X of the first exemplary embodiment. The rotational order is obtained by division of measured frequency F by a rotational frequency (r/60) of the intake and exhaust device. Generally, BPF noise energy is greater when the rotational order is a multiple of number N of rotor vanes. A broken line in FIG. 4 indicates the BPF noise energy of the exemplary embodiment's temperature conditioning unit 100X including first intake and exhaust device 10A and second intake and exhaust device 20A. A solid line in FIG. 4 indicates BPF noise energy of a temperature conditioning unit of a comparative example that includes two first intake and exhaust devices 10A. In the case of the exemplary embodiment, it is shown that BPF noise energy peaks are dispersed and that BPF noise is suppressed. When respective overall values (each of which represents total energy of sounds produced by the temperature conditioning unit at all frequencies) of those temperature conditioning units were compared, the overall value was about 2% lower in the exemplary embodiment compared with the overall value of the comparative example. While FIG. 4 shows the relationship between the rotational order and the BPF noise energy when first intake and exhaust device 10A includes eleven first rotor vanes 112A with second intake and exhaust device 20A including nine second rotor vanes 212A, a similar tendency is seen even when first intake and exhaust device 10A and second intake and exhaust device 20A each have the number of rotor vanes varied.

Number N1 of first rotor vanes 112A and number N2 of second rotor vanes 212A are not particularly limited. Number N1 of first rotor vanes 112A and number N2 of second rotor vanes 212A may be set appropriately in consideration of, for example, sizes of impellers 110A and 210A and respective gas volumes and respective pressures of first and second intake and exhaust devices 10A and 20A. Number N1 of first rotor vanes 112A is, for example, between 5 and 30 inclusive. Number N2 of second rotor vanes 212A is, for example, between 8 and 15 inclusive. As long as Relational Expression 1 and Relational Expression 2 are satisfied, the difference between number N1 and number N2 is not particularly limited and may be greater than or equal to 1. When the respective gas volumes and the respective pressures of first and second intake and exhaust devices 10A and 20A are taken into consideration, the difference between number N1 and number N2 is preferably between 1 and 5 inclusive.

In cases where an electric motor is used as rotary drive device 130, a stator is disposed in the electric motor. The stator generally has an even number of poles. For this reason, in cases where at least one of number N1 of first rotor vanes 112A and number N2 of second rotor vanes 212A is even, first rotor vanes 112A and second rotor vanes 212A become exciting forces, whereby rotary drive device 130, first intake and exhaust device 10A, and second intake and exhaust device 20A all experience vibrational excitation, and an increased noise can be caused. As such, it is preferable that number N1 of first rotor vanes 112A and number N2 of second rotor vanes 212A be both odd in such cases. The number of poles is a number of magnetic poles generated in rotary drive device 130. Even in cases where a number of slots of the stator corresponds to at least one of number N1 of first rotor vanes and number N2 of second rotor vanes 212A or even in cases where the number of slots and the at least one of number N1 and number N2 are integral multiples of each other, an increased noise can be caused. As such, each of number N1 of first rotor vanes and number N2 of second rotor vanes 212A is preferably set so as to neither correspond to the number of slots nor be the integral multiple of the number of slots or vice versa.

As illustrated in FIG. 3B, each of first rotor vanes 112A extends in the shape of the circular arc bulging in rotation direction D of shaft 131, starting from a point of choice as starting point 112As in central part 111AC and ending at a point of choice (end point 112Ae) in outer peripheral part 111AP. First rotor vane 112A includes a projecting portion that projects in rotation direction

D. Accordingly, gas taken into first intake and exhaust device 10A can flow out along the projecting portion in the direction from central part 111AC to outer peripheral part 111AP with the gas flow not being greatly disturbed. It is to be noted here that when impeller disk 111A has radius r, central part 111AC of impeller disk 111A is a circle that is concentric with impeller disk 111A and has a radius of 1/2×r. Outer peripheral part 111AP of impeller disk 111A is a doughnut-shaped area surrounding central part 111AC.

When rotor vanes are longer radially of an impeller disk, an impeller generally produces easily increased fluid energy. Since first rotor vane 112A including the above-described projecting portion does not easily disturb the gas flow, first rotor vane 112A can be made longer radially of impeller disk 111A. Because fluid energy is easily increased, end point 112Ae is preferably positioned near the outer peripheral edge of impeller disk 111A. From a similar point of view, starting point 112As is preferably near center C (e.g., in a circle that is concentric with impeller disk 111A and has a radius of 1/3×r).

The shape of first rotor vane 112A is not particularly limited as long as first rotor vane 112A includes the projecting portion. For example, when impeller 110A is viewed in the axial direction of shaft 131, straight line Ls connecting starting point 112As of first rotor vane 112A and center C of impeller disk 111A may be positioned ahead of straight line Le connecting end point 112Ae of first rotor vane 112A and center C of impeller disk 111A in rotation direction D.

### (Fan Case)

Fan case 120 includes side wall 121 surrounding impeller 110A, intake port 122, and vent 123 communicating with the interior of housing 30. In FIG. 2B, fan case 120 disposed is illustrated as having intake port 122 and vent 123 that face each other in the axial direction of shaft 131. However, fan case 120 is not limited to this shape. For example, fan case 120 may be scroll-shaped with a distance from shaft 131 to side wall 121 increasing in rotation direction D. In this case, gas drawn in at intake port 122 flows in an axial direction of shaft 131. When blown from vent 123, the gas flows in a direction intersecting the axial direction of shaft 131. Above all, fan case 120 that is illustrated in FIGS. 2A and 2B is preferable in terms of ease of reduction in size. With fan case 120 (specifically side wall 121) partly inserted in housing 30 in this case, temperature conditioning unit 100X can be made smaller in size. A description is hereinafter provided of fan case 120 illustrated in FIGS. 2A and 2B.

Side wall 121 is, for example, substantially cylindrical with shaft 131 being its center. A distance from shaft 131 to side wall 121 is substantially fixed. Side wall 121 includes shoulder 121S near an opening edge of intake port 122. Because of shoulder 121S, the opening edge of intake port 122 has a smaller diameter than an opening edge of vent 123. Intake port 122 is, for example, substantially circular with shaft 131 being its center. Vent 123 is, for example, doughnut-shaped encircling impeller disk 111A with shaft 131 being its center.

Intake port 122 and vent 123 are disposed to face each other in the axial direction of shaft 131. Gas around intake port 122 (generally, ambient air) is taken in through intake port 122 by rotation of first rotor vanes 112A. At the same time, the gas taken in through intake port 122 is given energy, gains speed, flows along first rotor vanes 112A, and flows out from the outer peripheral edge of impeller disk 111A. Subsequently, the gas changes its direction by colliding against side wall 121 of fan case 120 and then flows into housing 30 through vent 123. It is to be noted here that shoulder 121S is preferably formed to have a gently curved surface for suppressing a turbulent flow of gas.

Respective materials for the impeller disk, the rotor vane, the shroud, the side wall, and a stator vane that is described later are not particularly limited and are suitably selected based on a use. Given examples of those materials include various metallic materials, various resin materials, and combinations of these materials.

### (Rotary Drive Device)

Rotary drive device 130 includes shaft 131 and rotary drive source 132 that rotates shaft 131. As shaft 131 is rotationally driven by rotary drive source 132, impeller 110A rotates, and gas is taken into fan case 120 through intake port 122.

Rotary drive device 130 is, for example, the electric motor. The electric motor is an electric appliance that outputs rotational motion through use of force of interaction between a magnetic field and an electric current (namely, Lorentz force). In the electric motor, rotary drive source 132 includes a rotor (not illustrated) and the stator (not illustrated) that produces force to rotate the rotor. Respective shapes of and respective materials for the rotor and the stator are not particularly limited, and a publicly known electric motor may be used. An output of the electric motor is not particularly limited and may be set appropriately based on, for example, a desired gas volume and a desired pressure. For example, in cases where temperature conditioning unit 100X is mounted in a hybrid vehicle, the output of the electric motor is about several tens of watts.

The stator has stator windings. When the electric current is passed through the stator winding, a magnetic field is produced around the stator winding. The magnetic field causes the rotor to rotate. A material for the stator winding is not particularly limited as long as the material is electrically conductive. Above all, the stator winding preferably includes at least one selected from the group consisting of copper, copper alloy, aluminum, and aluminum alloy in terms of low resistance.

### (Blower Controller)

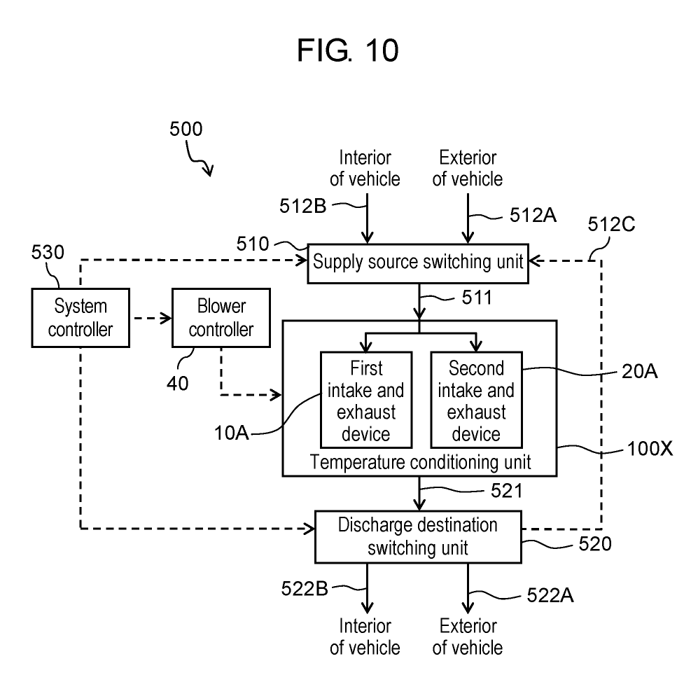

FIG. 10 is a block diagram illustrating first temperature conditioning system 500 according to the first exemplary embodiment. Temperature conditioning unit 100X may be provided with blower controller 40 (refer to FIG. 10) that controls first intake and exhaust device 10A and second intake and exhaust device 20A. Blower controller 40 controls, for example, the rotational speed of each of the impellers and an amount of gas that is supplied to each of the intake ports.

### (Element to Temperature-Condition)

Element 50 to temperature-condition is not particularly limited. Given examples of element 50 to temperature-condition include various devices that are mounted in a vehicle such as an electric vehicle or the hybrid vehicle. Those various devices include, for example, a power storage device including a secondary battery, power converters such as an inverter and a converter, an engine control unit, and a motor. The power storage device is formed of, for example, a battery pack that is a combination of a plurality of secondary batteries. A gap is formed between adjacent secondary batteries here, and gas passes through this gap. Similarly, even with the power converter having a gap formed between its components, gas passes through that gap.

A number of elements 50 to temperature-condition that are accommodated by housing 30 may be greater than or equal to 1 or may be greater than or equal to 2. In cases where elements 50 to temperature-condition that are accommodated by housing 30 are greater than or equal to two in number, the interior of housing 30 may be divided based on the number of elements 50 to temperature-condition. A course of gas blown from first intake and exhaust device 10A and a course of gas blown from second intake and exhaust device 20A may be independent of each other or may be connected. At least one of the gas course of first intake and exhaust device 10A and the gas course of second intake and exhaust device 20A may branch off based on the number of elements 50 to temperature-condition.

With reference to FIGS. 5 to 9, first rotor vanes 112A are compared below with rotor vanes (hereinafter “forward swept vanes 912”) that each have a projecting portion projecting in a direction opposite to rotation direction D in contrast to first rotor vanes 112A. FIG. 5 illustrates gas flow C effected by first rotor vane 112A disposed in first intake and exhaust device 10A of temperature conditioning unit 100X of the first exemplary embodiment. FIG. 6 illustrates gas flow C912 effected by forward swept vane 912 disposed in first intake and exhaust device 10A of temperature conditioning unit 100X of the first exemplary embodiment. In FIG. 5, end point 112Ae of first rotor vane 112A is positioned near the outer peripheral edge of impeller disk 111A. In FIG. 6, end point 912e of forward swept vane 912 is positioned near an outer peripheral edge of impeller disk 911 on which forward swept vane 912 is erected.

When first rotor vane 112A is rotated, as illustrated in FIG. 5, gas flow C is effected by first rotor vane 112A, making angle θ1 with line Li that is tangent to impeller disk 111A at end point 112Ae. When forward swept vane 912 is rotated, as illustrated in FIG. 6, gas flow C912 is effected by forward swept vane 912, making angle θ2 with line Lif that is tangent to impeller disk 911 at end point 912e. Here angle θ1 is greater than angle θ2. This means that gas flow C effected by first rotor vane 112A has larger flow component Cb in a direction indicated by line Lb that is tangent to first rotor vane 112A at end point 112Ae compared with flow component Cf in a direction indicated by line Lf that is tangent to forward swept vane 912 at end point 912e. For this reason, fluid energy produced by impeller 110A is greater when first rotor vanes 112A are used compared to when forward swept vanes 912 are used.

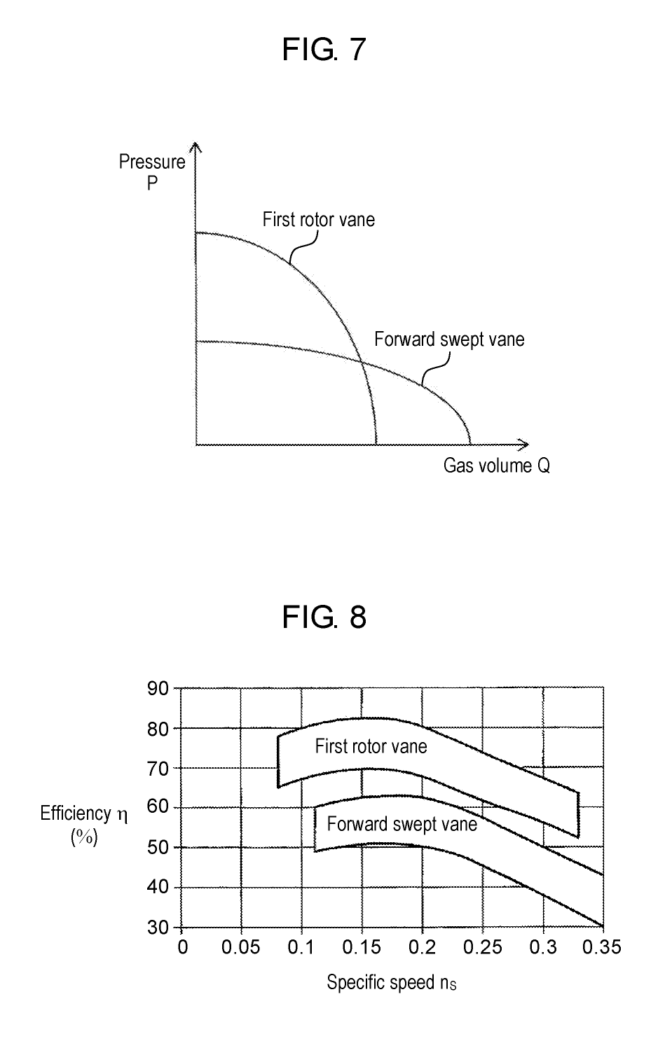

FIG. 7 is a graph showing respective gas volume Q-pressure P relationships of the gas flows that are respectively effected by first rotor vane 112A disposed in first intake and exhaust device 10A of temperature conditioning unit 100X of the first exemplary embodiment and forward swept vane 912 disposed in first intake and exhaust device 10A of temperature conditioning unit 100X of the first exemplary embodiment. As described above, first rotor vane 112A can be made longer radially of impeller disk 111A. With first rotor vane 112A being longer radially of impeller disk 111A, a gas flow velocity difference is increased between starting point 112As and end point 112Ae when impeller 110A is rotated. Thus, as illustrated by FIG. 7, intake and exhaust device 10A including first rotor vanes 112A can perform high-pressure blowing, irrespective of the shape of the fan case. On the other hand, forward swept vane 912 cannot be made longer radially of impeller disk 911 compared with first rotor vane 112A because forward swept vane 912 easily disturbs the gas flow. Accordingly, pressure of an intake and exhaust device including forward swept vanes 912 is generally increased by a scroll-shaped fan case (see above). This means that first intake and exhaust device 10A including first rotor vanes 112A can be reduced in size. Moreover, because the pressure is high, first intake and exhaust device 10A including first rotor vanes 112A is suitable for cooling or heating (temperature-conditioning) of element 50 even with increased pressure resistance due to the reduction in size.

FIG. 8 is a graph showing a specific speed nₛ-fan efficiency η (%) relationship of first intake and exhaust device 10A using first rotor vanes 112A in temperature conditioning unit 100X of the first exemplary embodiment and a specific speed nₛ-fan efficiency η (%) relationship of first intake and exhaust device 10A using forward swept vanes 912 in temperature conditioning unit 100X of the first exemplary embodiment. When forward swept vanes 912 are used, with increasing specific speed nₛ, energy loss increases, and fan efficiency η decreases. When first rotor vanes 112A are used, while energy loss increases with increasing specific speed nₛ, higher fan efficiency is exhibited than when forward swept vanes 912 are used.

Specific speed nₛ is obtained by Formula 2.

nₛ=r×√Q/(gH)^{3/4} Formula 2

where r is rotational speed (per minute), Q is a flow rate (m³/min), g is gravitational acceleration (m/s²), and H is head (m).

Fan efficiency η is obtained by Formula 3.

η=E/P Formula 3

where E is effective energy per second (J/s) that gas receives from the impeller, and P is drive shaft power (W).

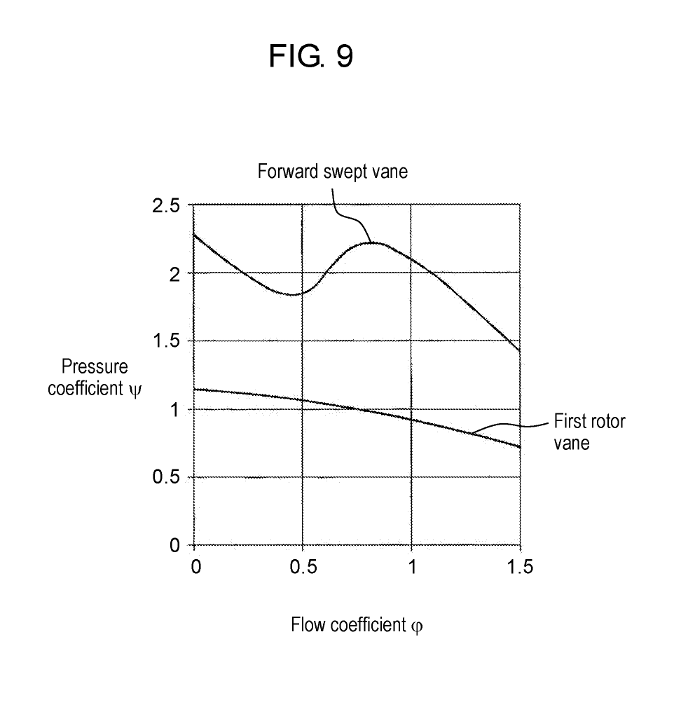

FIG. 9 is a graph showing a flow coefficient (1)-pressure coefficient w relationship of first intake and exhaust device 10A using first rotor vanes 112A in temperature conditioning unit 100X of the first exemplary embodiment and a flow coefficient ϕ-pressure coefficient Ψ relationship of first intake and exhaust device 10A using forward swept vanes 912 in temperature conditioning unit 100X of the first exemplary embodiment. When forward swept vanes 912 are used in the intake and exhaust device, pressure coefficient Ψ is higher than when first rotor vanes 112A are used, irrespective of flow coefficient ϕ. However, with increasing flow coefficient ϕ, pressure coefficient Ψ of the intake and exhaust device greatly fluctuates between a positive side and a negative side, showing an unsteady tendency. On the other hand, when first rotor vanes 112A are used in the intake and exhaust device, even with increasing flow coefficient ϕ, pressure coefficient Ψ decreases only gently. In other words, intake and exhaust device 10A including first rotor vanes 112A exhibits steady pressure coefficient Ψ that is not greatly affected by flow coefficient ϕ, so that high-speed rotation cab be carried out for an increased gas volume.

Pressure coefficient Ψ is obtained by Formula 4.

Ψ=2×g×H/u² Formula 4

where H is head (m), and u is peripheral speed (m/s) of a periphery (fan outside diameter) of a circle formed by connection of end points 112Ae of the plurality of first rotor vanes. It is to be noted that in the preset exemplary embodiment, respective outside diameters of impeller disk 111A and shroud 113A correspond to the above fan outside diameter.

As described above, temperature conditioning unit 100X according to the present exemplary embodiment includes first intake and exhaust device 10A, second intake and exhaust device 20A, and housing 30 that accommodates element 50 to temperature-condition. First intake and exhaust device 10A and second intake and exhaust device 20A each include: rotary drive device 130 including shaft 131 and rotary drive source 132 that rotates shaft 131; impeller 110A including impeller disk 111A that engages shaft 131 at central part 111AC and includes the surface extending in the direction intersecting shaft 131, and a plurality of rotor vanes corresponding to first rotor vanes 112A erected on impeller disk 111A; and fan case 120 including side wall 121 surrounding impeller 110A, intake port 122, and vent 123 communicating with the interior of housing 30. The plurality of rotor vanes each extend in the direction from central part 111AC to outer peripheral part 111AP of the impeller disk in the shape of the circular arc bulging in the rotation direction of shaft 131. Frequency Fb1 at which first intake and exhaust device 10A produces a sound having an energy peak is different from frequency Fb2 at which second intake and exhaust device 20A produces a sound having an energy peak.

In this way, a noise is produced in suppressed condition by the temperature conditioning unit including the plurality of intake and exhaust devices.

It is to be noted here that intake port 122 and vent 123 are disposed to face each other in the axial direction of the shaft.

Number N1 of first rotor vanes 112A of first intake and exhaust device 10A and number N2 of second rotor vanes 212A of second intake and exhaust device 20A preferably satisfy the relationships:

N1≠N2×n1 (where n1 is the integer greater than or equal to 1); and

N1≠N2/n2 (where n2 is the integer greater than or equal to 2).

Temperature conditioning unit 100X may also be provided with blower controller 40 that controls first intake and exhaust device 10A and second intake and exhaust device 20A.

Element 50 to temperature-condition may be the secondary battery.

Another alternative may be that element 50 to temperature-condition is the power converter.

At least one of rotary drive device 130 of first intake and exhaust device 10A and rotary drive device 130 of second intake and exhaust device 20A may be the electric motor.

The stator winding of the electric motor preferably includes at least one selected from the group consisting of copper, copper alloy, aluminum, and aluminum alloy.

The distance from shaft 131 to side wall 121 of fan case 120 may increase in rotation direction D of shaft 131.

Gas drawn in at intake port 122 preferably flows in the direction along shaft 131, and when blown from vent 123, the gas preferably flows in the direction intersecting shaft 131.

### (Temperature Conditioning Systems)

A description is provided next of temperature conditioning systems.

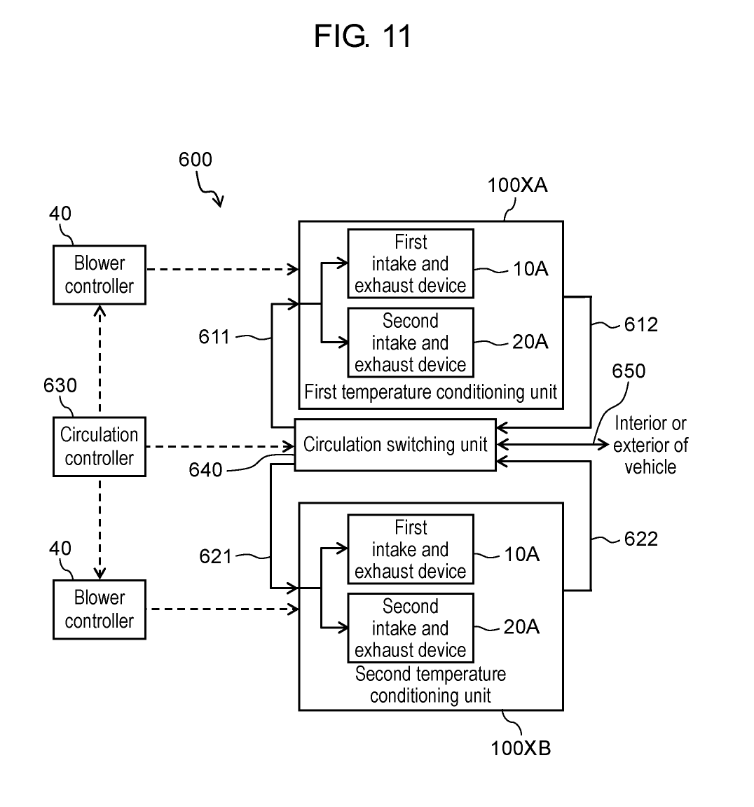

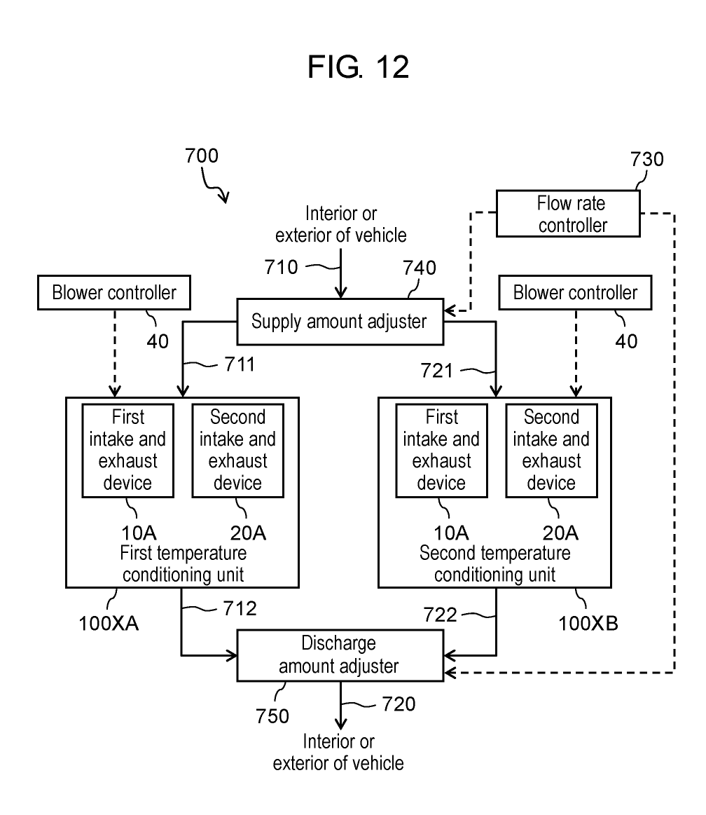

The temperature conditioning systems are each formed to include a plurality of ducts connected to temperature conditioning unit(s) 100X. With reference to FIGS. 10 to 12, the temperature conditioning systems according to the first exemplary embodiment are hereinafter described specifically. FIG. 10 is the block diagram illustrating first temperature conditioning system 500 according to the first exemplary embodiment. FIG. 11 is a block diagram illustrating second temperature conditioning system 600 according to the first exemplary embodiment. FIG. 12 is a block diagram illustrating third temperature conditioning system 700 according to the first exemplary embodiment. In the drawings, members having identical functions have the same reference marks. In the following description, an example in which each of the temperature conditioning systems is mounted in the hybrid vehicle is given; however, the present invention is not limited to this.

### (First Temperature Conditioning System)

As illustrated in FIG. 10, first temperature conditioning system 500 includes, for example, intake duct 511, a plurality of supply ducts, and system controller 530. Intake duct 511 connects with the respective intake ports of first intake and exhaust device 10A and second intake and exhaust device 20A of temperature conditioning unit 100X. The plurality of supply ducts each supply gas to intake duct 511 and includes, in FIG. 10, first supply duct 512A, second supply duct 512B, and third supply duct 512C. System controller 530 controls gas supply sources for temperature conditioning unit 100X.

Intake duct 511 connects with supply ducts 512A to 512C via supply source switching unit 510. First supply duct 512A has one end connecting with an exterior of the vehicle and another end connecting with supply source switching unit 510. Second supply duct 512B has one end connecting with an interior of the vehicle and another end connecting with supply source switching unit 510. Third supply duct 512C has one end connecting with discharge destination switching unit 520 that is described later and another end connecting with supply source switching unit 510. It is to be noted that the one end of third supply duct 512C may connect directly with the outlets (not illustrated) of temperature conditioning unit 100X.

Supply source switching unit 510 is controlled by system controller 530. Supply source switching unit 510 opens or closes parts of connection with supply ducts 512A to 512C to effect switching(s) among the gas supply sources for temperature conditioning unit 100X. The gas supplied from any one of supply ducts 512A to 512C passes through intake duct 511 and is taken into the impellers through the respective intake ports of first and second intake and exhaust devices 10A and 20A. The amount of gas supply for each of first and second intake and exhaust devices 10A and 20A is controlled by blower controller 40. System controller 530 controls supply source switching unit 510 that supplies the gas to temperature conditioning unit 100X. System controller 530 may control a flow rate of gas that is supplied to intake duct 511. Moreover, system controller 530 may control blower controller 40.

In cases where a temperature outside the vehicle is a temperature (hereinafter “cooling temperature”) suitable for cooling of element 50 to temperature-condition, supply source switching unit 510 opens the part of connection with first supply duct 512A to supply gas from outside the vehicle to temperature conditioning unit 100X. In cases where a temperature of the vehicle's interior is the cooling temperature or a temperature (hereinafter “heating temperature”) that is suited to heat element 50 to temperature-condition, supply source switching unit 510 opens the part of connection with second supply duct 512B to supply gas from the interior of the vehicle to temperature conditioning unit 100X. In cases where exhaust gas from temperature conditioning unit 100X has a cooling temperature or a heating temperature, supply source switching unit 510 may open the part of connection with third supply duct 512C to supply the exhaust gas to temperature conditioning unit 100X.

First temperature conditioning system 500 also includes discharge duct 521 connecting with the outlets of temperature conditioning unit 100X, exhaust duct 522A that lets the gas out of the vehicle, and exhaust duct 522B that discharges the gas into the interior of the vehicle. Discharge duct 521 connects with exhaust duct 522A and exhaust duct 522B via discharge destination switching unit 520. Exhaust duct 522A has one end connecting with the exterior of the vehicle and another end connecting with discharge destination switching unit 520. Exhaust duct 522B has one end connecting with the interior of the vehicle and another end connecting with discharge destination switching unit 520. As described above, discharge destination switching unit 520 also connects with the other end of third supply duct 512C.

Also discharge destination switching unit 520 is controlled by system controller 530. Discharge destination switching unit 520 opens or closes parts of connection with exhaust duct 522A, exhaust duct 522B, and third supply duct 512C to effect switching(s) among discharge destinations for the gas from temperature conditioning unit 100X. System controller 530 changes the discharge destination(s) of the gas from temperature conditioning unit 100X and may control a flow rate of gas that is discharged into discharge duct 521.

Discharged gas generally has a higher temperature than gas that is drawn in. As such, when the interior (particularly an internal cabin space) of the vehicle has a lower temperature, discharge destination switching unit 520 preferably opens the part of connection with exhaust duct 522B. In this way, the warmer gas is discharged into the vehicle's interior, and the vehicle's interior can be warmed up accordingly. In cases where the temperature of the vehicle's interior is high enough, discharge destination switching unit 520 opens the part of connection with exhaust duct 522A to let the gas out of the vehicle.

As described above, first temperature conditioning system 500 according to the present exemplary embodiment includes temperature conditioning unit 100X, intake duct 511 connecting with respective intake ports 122 of first and second intake and exhaust devices 10A and 20A, the plurality of supply ducts respectively corresponding to first supply duct 512A, second supply duct 512B, and third supply duct 512C that supply gas to intake duct 511, and system controller 530 that selects one or more from among the plurality of supply ducts to effect supply of the gas to intake duct 511.

Thus, in first temperature conditioning system 500, the gas supply source(s) for element 50 to temperature-condition and the discharge destination(s) of gas discharged from element 50 to temperature-condition can be changed based on the temperature outside the vehicle, the temperature of the vehicle's interior, and the temperature of the gas discharged from temperature conditioning unit 100X. In other words, according to first temperature conditioning system 500, the gas from outside the vehicle or from the vehicle's interior is taken in, or the gas is discharged into the vehicle's interior. In this way, element 50 can be temperature-conditioned while energy is effectively utilized. Moreover, with gas taken in from outside the vehicle or from a closed space in the vehicle or with gas discharged out of the vehicle or into the closed space in the vehicle, gas quantity is equalized between intake and discharge, thus enabling suppression of pressure changes in the vehicle's interior.

### (Second Temperature Conditioning System)

There are also cases where a plurality of temperature conditioning units 100X are disposed in the hybrid vehicle. In such cases, from the viewpoint of effective energy utilization, respective gas courses of temperature conditioning units 100X may be connected to each other to achieve a gas circulation system. This facilitates equalization of gas quantity between intake and discharge, thus leading to suppression of pressure changes in the interior of the vehicle.

As illustrated in FIG. 11, second temperature conditioning system 600 that allows gas circulation between the plurality of temperature conditioning units includes, for example, first temperature conditioning unit 100XA, second temperature conditioning unit 100XB, intake duct 611, exhaust duct 612, intake duct 621, exhaust duct 622, and circulation controller 630. Intake duct 611 connects with the respective intake ports of first intake and exhaust device 10A and second intake and exhaust device 20A of first temperature conditioning unit 100XA. Exhaust duct 612 lets gas out from the outlets of first temperature conditioning unit 100XA. Intake duct 621 connects with the respective intake ports of first intake and exhaust device 10A and second intake and exhaust device 20A of second temperature conditioning unit 100XB. Exhaust duct 622 lets gas out from the outlets of second temperature conditioning unit 100XB. From exhaust duct 612 and exhaust duct 622, circulation controller 630 determines exhaust duct(s) for connection to at least one of intake duct 611 and intake duct 621.

Intake duct 611, intake duct 621, exhaust duct 612, and exhaust duct 622 are interconnected via circulation switching unit 640. In other words, intake duct 611 has one end connecting with the intake ports of first temperature conditioning unit 100XA and another end connecting with circulation switching unit 640. Exhaust duct 612 has one end connecting with the outlets of first temperature conditioning unit 100XA and another end connecting with circulation switching unit 640. Intake duct 621 has one end connecting with the intake ports of second temperature conditioning unit 100XB and another end connecting with circulation switching unit 640. Exhaust duct 622 has one end connecting with the outlets of second temperature conditioning unit 100XB and another end connecting with circulation switching unit 640. Circulation switching unit 640 may also connect with one end of duct 650. Another end of duct 650 connects with, for example, the exterior or the interior of the vehicle. Duct 650 takes in gas from outside the vehicle or from the vehicle's interior or discharges the gas out of the vehicle or into the vehicle's interior when necessary.

Circulation switching unit 640 is controlled by circulation controller 630. From exhaust duct 612 and exhaust duct 622, circulation controller 630 determines exhaust duct(s) for connection to at least one of intake duct 611 or intake duct 621. Based on this determination, circulation switching unit 640 opens or closes parts of connection with intake duct 611, intake duct 621, exhaust duct 612, and exhaust duct 622 to effect switching(s) among gas supply sources or gas discharge destinations for first temperature conditioning unit 100XA and second temperature conditioning unit 100XB. Circulation controller 630 may also control a flow rate of gas in each of the ducts. The amount of gas supply for each of the intake and exhaust devices of each of the temperature conditioning units is controlled by corresponding blower controller 40. Circulation controller 630 may also control blower controllers 40.

As described above, second temperature conditioning system 600 according to the present exemplary embodiment includes first temperature conditioning unit 100XA, second temperature conditioning unit 100XB, a first intake duct that corresponds to intake duct 611 connecting with respective intake ports 122 of first intake and exhaust device 10A and second intake and exhaust device 20A of first temperature conditioning unit 100XA, a first exhaust duct corresponding to exhaust duct 612 that lets gas out from outlets 30b of first temperature conditioning unit 100XA, a second intake duct that corresponds to intake duct 621 connecting with respective intake ports 122 of first intake and exhaust device 10A and second intake and exhaust device 20A of second temperature conditioning unit 100XB, a second exhaust duct corresponding to exhaust duct 622 that lets gas out from outlets 30b of second temperature conditioning unit 100XB, and circulation controller 630 that selects at least one of the first exhaust duct and the second exhaust duct to effect supply of the gas to at least one of the first intake duct and the second intake duct.

With second temperature conditioning system 600, elements 50 can be temperature-conditioned while energy is effectively utilized through gas circulation between the plurality of temperature conditioning units. Such a system is useful in cases where gas discharged from first temperature conditioning unit 100XA or second temperature conditioning unit 100XB has a suitable temperature for cooling or heating of element 50 to temperature-condition. While second temperature conditioning system 600 has two temperature conditioning units 100XA and 100XB in the illustrated example, it is to be noted that this is not limiting. Second temperature conditioning system 600 may, for example, include one temperature conditioning unit 100XA or 100XB and another temperature conditioning unit (such as the one that includes one intake and exhaust device). The temperature conditioning units of second temperature conditioning system 600 may be greater than or equal to three in number with gas circulated at least between two of those temperature conditioning units. While temperature conditioning units 100XA and 100XB each have two intake and exhaust devices 10A and 20B in the illustrated example, this is not limiting. Each of temperature conditioning units 100XA and 100XB may, for example, include intake and exhaust devices that are greater than or equal to three in number. Temperature conditioning units 100XA and 100XB may have the same intake and exhaust devices disposed or different intake and exhaust devices disposed. The same goes for a third temperature conditioning system that is described later.

### (Third Temperature Conditioning System)

In cases where a plurality of temperature conditioning units 100X are disposed, temperature conditioning units 100X may be connected in parallel for collective quantitative control of gases that are respectively drawn into temperature conditioning units 100X. This enables effective energy utilization.

As illustrated in FIG. 12, third temperature conditioning system 700 having the plurality of temperature conditioning units 100X connected in parallel includes, for example, first temperature conditioning unit 100XA, second temperature conditioning unit 100XB, intake duct 711, intake duct 721, intake connection duct 710, and flow rate controller 730. Intake duct 711 connects with the respective intake ports of first intake and exhaust device 10A and second intake and exhaust device 20A of first temperature conditioning unit 100XA. Intake duct 721 connects with the respective intake ports of first intake and exhaust device 10A and second intake and exhaust device 20A of second temperature conditioning unit 100XB. Intake connection duct 710 branches off to connect with intake duct 711 and intake duct 721. Flow rate controller 730 controls a flow rate of gas in intake duct 711 and a flow rate of gas in intake duct 721.

Intake connection duct 710 connects with intake duct 711 and intake duct 721 via supply amount adjuster 740. Intake connection duct 710 connects with, for example, the exterior or the interior of the vehicle. Supply amount adjuster 740 is controlled by flow rate controller 730. Supply amount adjuster 740 opens or closes parts of connection with intake duct 711 and intake duct 721 to adjust an amount of gas supply for first temperature conditioning unit 100XA and an amount of gas supply for second temperature conditioning unit 100XB. The amount of gas supply for each of first and second intake and exhaust devices 10A and 20A of each of the temperature conditioning units is controlled by corresponding blower controller 40. Flow rate controller 730 may also control blower controllers 40.

Third temperature conditioning system 700 may also include exhaust duct 712, exhaust duct 722, and exhaust connection duct 720. Exhaust duct 712 connects with the outlets of first temperature conditioning unit 100XA. Exhaust duct 722 connects with the outlets of second temperature conditioning unit 100XB. Exhaust connection duct 720 connects with exhaust duct 712 and exhaust duct 722.

Exhaust connection duct 720 connects with exhaust duct 712 and exhaust duct 722 via discharge amount adjuster 750. Exhaust connection duct 720 connects with, for example, the exterior or the interior of the vehicle. Discharge amount adjuster 750 is controlled by flow rate controller 730. Discharge amount adjuster 750 opens or closes parts of connection with exhaust duct 712 and exhaust duct 722 to adjust an amount of gas discharge from first temperature conditioning unit 100XA and an amount of gas discharge from second temperature conditioning unit 100XB.

As described above, third temperature conditioning system 700 according to the present exemplary embodiment includes first temperature conditioning unit 100XA, second temperature conditioning unit 100XB, a first intake duct that corresponds to intake duct 711 connecting with respective intake ports 122 of first intake and exhaust device 10A and second intake and exhaust device 20A of first temperature conditioning unit 100XA, a second intake duct that corresponds to intake duct 721 connecting with respective intake ports 122 of first intake and exhaust device 10A and second intake and exhaust device 20A of second temperature conditioning unit 100XB, a connection duct corresponding to intake connection duct 710 that branches off and connects with the first intake duct and the second intake duct, and flow rate controller 730 that controls the flow rate of gas in the first intake duct and the flow rate of gas in the second intake duct.

With third temperature conditioning system 700, elements 50 can be temperature-conditioned while energy is effectively utilized through collective quantitative control of gases that are respectively drawn into the plurality of temperature conditioning units (first and second temperature conditioning units 100XA and 100XB in FIG. 12).

### (Vehicles)

Temperature conditioning unit 100X, temperature conditioning system 500, temperature conditioning system 600, or temperature conditioning system 700 is mounted, for example, in vehicles including the hybrid vehicle.

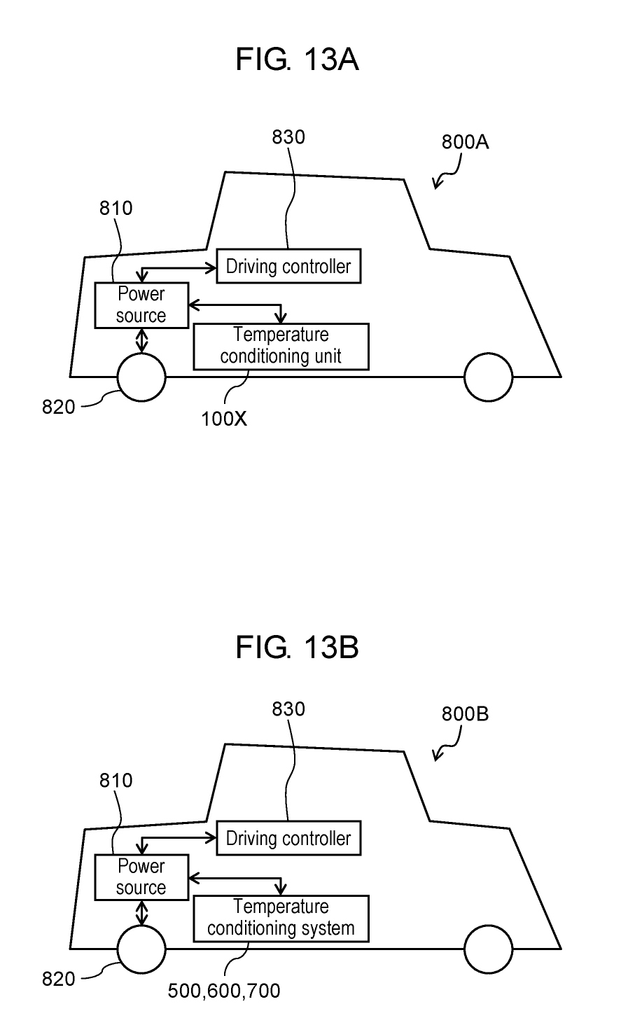

FIG. 13A is a schematic view of vehicle 800A according to the first exemplary embodiment. Vehicle 800A includes power source 810, drive wheels 820, driving controller 830, and temperature conditioning unit 100X. Power source 810 supplies power to drive wheels 820. Driving controller 830 controls power source 810.

FIG. 13B is a schematic view of another vehicle 800B according to the first exemplary embodiment. Vehicle 800B includes power source 810, drive wheels 820, driving controller 830, and temperature conditioning system 500, 600, or 700. Vehicles 800A and 800B can allow the secondary batteries and others to function at suitable temperatures with noises suppressed, thus each offering excellent comfort and high performance.

As described above, vehicle 800A according to the present exemplary embodiment may be mounted with temperature conditioning unit 100X.

Vehicle 800B may be mounted with temperature conditioning system 500.

Another alternative may be that vehicle 800B is mounted with temperature conditioning system 600.

Yet another alternative may be that vehicle 800B is mounted with temperature conditioning system 700.

### Second Exemplary Embodiment

The present exemplary embodiment differs from the first exemplary embodiment in that a plurality of intake and exhaust devices to use have the same number N of rotor vanes disposed and that an impeller of at least one of the intake and exhaust devices (a first intake and exhaust device) and an impeller of another intake and exhaust device (a second intake and exhaust device) rotate at different rotational speeds r. A temperature conditioning unit, temperature conditioning systems, and vehicles are otherwise similar to those in the first exemplary embodiment. With the impellers varying in rotational speed r, BPF noise frequency Fb1 of the first intake and exhaust device does not coincide with BPF noise frequency Fb2 of the second intake and exhaust device. In this way, BPF noise peaks are dispersed, and a noise is produced in suppressed condition by the temperature conditioning unit.

Variations in rotational speed r result in variations in gas volume obtained. When cooling efficiency and ease of control are taken into account, it is preferable that a plurality of intake and exhaust devices disposed in one temperature conditioning system be comparable in gas volume. To achieve comparable gas volumes with variations in rotational speed r, maximum diameter L1 of an impeller disk of the first intake and exhaust device and maximum diameter L2 of an impeller disk of the second intake and exhaust device are varied in the present exemplary embodiment when these impeller disks are each viewed in an axial direction of a shaft. The impeller having the smaller impeller disk is rotated at a higher speed than the other impeller is rotated, thereby being adjusted to a comparable gas volume.

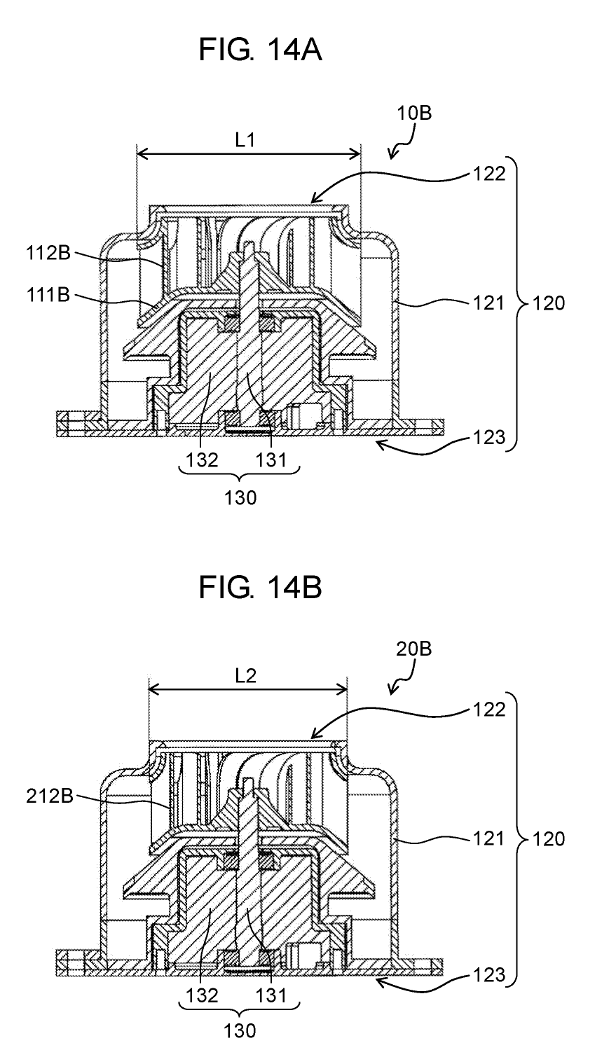

With reference to FIGS. 14A and 14B, a description is provided of the intake and exhaust devices according to the present exemplary embodiment. FIG. 14A is a sectional view of first intake and exhaust device 10B according to the second exemplary embodiment. FIG. 14B is a sectional view of second intake and exhaust device 20B according to the second exemplary embodiment. First intake and exhaust device 10B and second intake and exhaust device 20B may be structurally similar, except that impeller disk 111B has the different maximum diameter when viewed in the axial direction of the shaft. This means that first rotor vanes 112B of first intake and exhaust device 10B are the same in number as second rotor vanes 212B of second intake and exhaust device 20B. Moreover, fan case 120 of first intake and exhaust device 10B has the same outside diameter as fan case 120 of second intake and exhaust device 20B. First intake and exhaust device 10B and second intake and exhaust device 20B are not structurally limited to this, but may differ in the number of rotor vanes disposed or may have fan cases 120 of different outside diameters. In FIGS. 14A and 14B, first intake and exhaust device 10B and second intake and exhaust device 20B are structurally similar to first intake and exhaust device 10A but are not limited to this. It is to be noted that FIGS. 14A and 14B show that maximum diameter L1>maximum diameter L2.

L1/L2, which is a ratio of maximum diameter L1 to maximum diameter L2, is not particularly limited and may be determined appropriately in consideration of, for example, desired gas volumes and desired rotational speeds of the intake and exhaust devices. In the case of L1>L2, L1/L2 is, for example, greater than 1 and less than or equal to 1.7 and is preferably greater than 1 and less than or equal to 1.4. In the above cases, an operating point of a rotary drive source of first intake and exhaust device 10B and an operating point of a rotary drive source of second intake and exhaust device 20B do not have to be varied largely. For this reason, rotary drive sources 132 of the same type can be used in first intake and exhaust device 10B and second intake and exhaust device 20B, respectively. The operating point of the rotary drive source is a point of intersection of a speed characteristic curve that shows a rotational speed with respect to an electric current and a torque characteristic curve that shows torque with respect to the electric current.

As described above, in temperature conditioning unit 100X according to the present exemplary embodiment, maximum diameter L1 of impeller disk 111A of first intake and exhaust device 10A is different from maximum diameter L2 of impeller disk 211 of second intake and exhaust device 20A when these impeller disks 111A and 211 are each viewed in the axial direction of shaft 131. In this way, BPF noise peaks are dispersed, and a noise is produced in suppressed condition by the temperature conditioning unit.

### Third Exemplary Embodiment

A temperature conditioning unit, temperature conditioning systems, and vehicles according to the present exemplary embodiment are similar to those in the first or second exemplary embodiment, except that a first intake and exhaust device also includes a plurality of stator vanes disposed between the side wall and the rotor vanes.

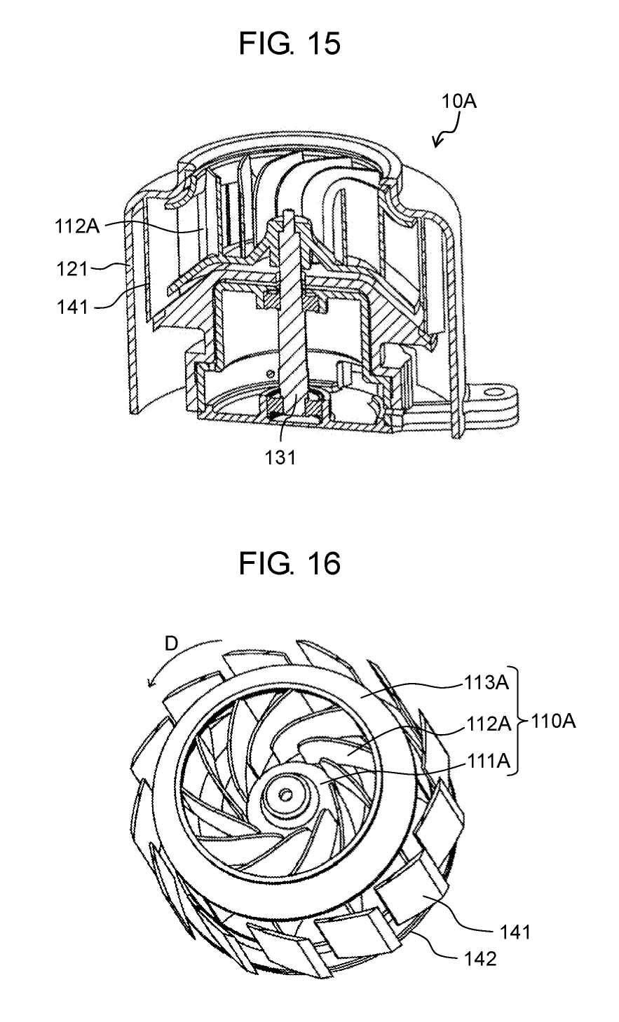

With reference to FIGS. 15 and 16, a description is provided of the present exemplary embodiment. FIG. 15 is a sectional perspective view of first intake and exhaust device 10A according to the third exemplary embodiment. FIG. 16 is a perspective view illustrating impeller 110A and stator vanes 141 according to the third exemplary embodiment. While FIGS. 15 and 16 illustrate the example in which first intake and exhaust device 10A includes stator vanes 141, this is not limiting. First intake and exhaust device 10B or second intake and exhaust device 20A or 20B may replace first intake and exhaust device 10A to include stator vanes 141. First intake and exhaust device 10A or 10B and second intake and exhaust device 20A or 20B may both include stator vanes 141. Because of stator vanes 141 disposed, air flowing out from impeller 110A is slowed down and increases in pressure when blown from the intake and exhaust device.

The plurality of stator vanes 141 are disposed between side wall 121 and first rotor vanes 112A while being erected, for example, at equally spaced intervals on a principal surface of diffuser ring 142 closer to intake port 122 (refer to FIG. 16). The plurality of stator vanes 141 may be joined to an inner side of side wall 121. Diffuser ring 142 is a ring-shaped plate and has a larger inside diameter than maximum diameter L1 of impeller disk 111A.

It is to be noted here that in cases where stator vanes 141 are disposed, a BPF noise can be caused by, for example, differential pressure or turbulence that occurs between stator vanes 141. When stator vanes 141 are included in first intake and exhaust device 10A, BPF noises are dispersed further in terms of energy. To this end, it is preferable that number N1 of first rotor vanes 112A of first intake and exhaust device 10A and number Nd1 of stator vanes 141 of first intake and exhaust device 10A satisfy Relational Expression 3 and Relational Expression 4.

N1≠Nd1×n3 (where n3 is an integer greater than or equal to 1) Relational Expression 3

N1≠Nd1/n4 (where n4 is an integer greater than or equal to 2) Relational Expression 4

As long as Relational Expression 3 and Relational Expression 4 are satisfied, number Nd1 of stator vanes 141 is not particularly limited and may be set appropriately in consideration of, for example, a size of the intake and exhaust device or a desired gas volume. Number Nd1 of stator vanes 141 is, for example, between 5 and 30 inclusive and preferably between 8 and 15 inclusive. Above all, from the viewpoint of a flow regulating effect, number Nd1 is preferably greater than number N1. If number Nd1 of stator vanes 141 is less than or equal to the number of first rotor vanes 112A, a space between adjacent stator vanes 141 becomes wider than a space between first rotor vanes 112A that are positioned inwardly of stator vanes 141, thereby easily lowering the flow regulating effect. On the other hand, if there are too many stator vanes 141, increased friction loss is caused to gas by side wall 121. A difference between number N1 and number Nd1 is not particularly limited and may be greater than or equal to 1. The difference between number N1 and number Nd1 is, for example, between 1 and 5 inclusive. Frequency Fd at which BPF noise energy ascribable to stator vanes 141 peaks is calculated by Formula 1 with number Nd of stator vanes 141 substituted for number N of rotor vanes.

Similarly, even in cases where second intake and exhaust device 20A includes stator vanes 141, number N2 of rotor vanes 212A of second intake and exhaust device 20A and number Nd2 of stator vanes of second intake and exhaust device 20A preferably satisfy Relational Expression 5 and Relational Expression 6.

N2‥Nd2×n4 (where n4 is an integer greater than or equal to 1) Relational Expression 5

N2‥Nd2/n6 (where n6 is an integer greater than or equal to 1) Relational Expression 6

Disposition of stator vanes 141 is not particularly limited. Stator vanes 141 may be suitably disposed based on, for example, the maximum diameter of impeller disk 111A or disposition of first rotor vanes 112A. Above all, each of stator vanes 141 is preferably disposed to have its principal surface extend along gas flow C (refer to FIG. 5) that is effected by first rotor vane 112A in terms of efficient deceleration of air flowing out from impeller 110A. In other words, each of stator vanes 141 is preferably disposed at such an angle as to open in rotation direction D. In this case, a size of stator vane 141 is not particularly limited and may be set appropriately to allow a desired volume of gas to be blown from between stator vanes 141 at a desired pressure.

As described above, at least one of first intake and exhaust device 10A and second intake and exhaust device 20A according to the preset exemplary embodiment may include the plurality of stator vanes 141 disposed between side wall 121 of fan case 120 and the rotor vanes corresponding to first rotor vanes 112A.

First intake and exhaust device 10A includes the plurality of stator vanes 141, and number N1 of rotor vanes corresponding to first rotor vanes 112A of first intake and exhaust device 10A and number Nd1 of stator vanes 141 of first intake and exhaust device 10A preferably satisfy the relationships:

N1≠Nd1×n3 (where n3 is the integer greater than or equal to 1); and

N1≠Nd1/n4 (where n4 is the integer greater than or equal to 2).

Moreover, second intake and exhaust device 20A includes the plurality of stator vanes 141, and number N2 of rotor vanes corresponding to first rotor vanes 112A of second intake and exhaust device 20A and number Nd2 of stator vanes 141 of second intake and exhaust device 20A preferably satisfy the relationships:

N2≠Nd2×n5 (where n5 is the integer greater than or equal to 1); and

N2≠Nd2/n6 (where n6 is the integer greater than or equal to 2).

### Fourth Exemplary Embodiment

Temperature conditioning unit 100Y according to the present exemplary embodiment is similar to the temperature conditioning unit of the first, second or third exemplary embodiment and is also similar to those in the temperature conditioning systems and the vehicles of the first, second or third exemplary embodiment, except that respective intake ports 122 of the first and second intake and exhaust devices are mounted to face outlets 30b, respectively. It is to be noted that in each of temperature conditioning systems, the intake duct and the exhaust duct, for example, are appropriately replaced before connection to temperature conditioning unit 100Y. In this way, internal gas of housing 30 is discharged through the intake and exhaust devices. This means that the intake and exhaust devices function as dischargers in the present exemplary embodiment.

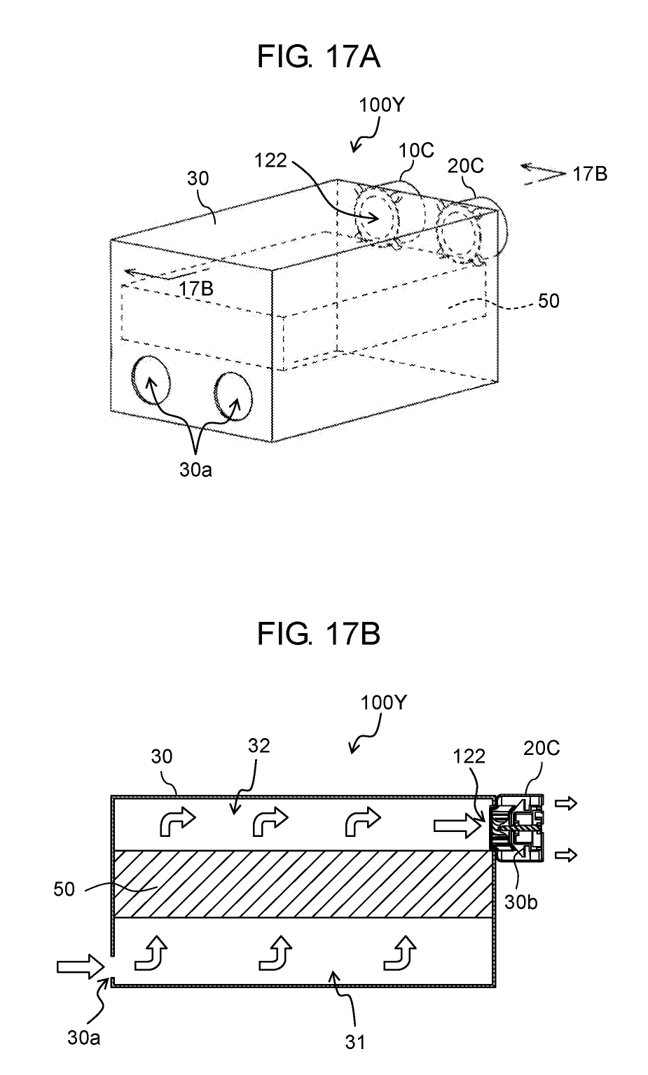

With reference to FIGS. 17A and 17B, a specific description is hereinafter provided of temperature conditioning unit 100Y according to the present exemplary embodiment. FIG. 17A is a perspective view schematically illustrating temperature conditioning unit 100Y according to the fourth exemplary embodiment. FIG. 17B is a sectional view of temperature conditioning unit 100Y, the section being taken on plane 17B-17B of FIG. 17A. It is to be noted that an internal structure of each of the intake and exhaust devices is omitted in FIG. 17A. First intake and exhaust device 10C is structurally similar to first intake and exhaust device 10A or first intake and exhaust device 10B, and second intake and exhaust device 20C is structurally similar to second intake and exhaust device 20A or second intake and exhaust device 20B. It is to be noted that temperature conditioning unit 100Y is not limited to the above structure.

Element 50 to temperature-condition is disposed, for example, to divide the interior of housing 30 into intake-side chamber 31 including inlets 30a and exhaust-side chamber 32 including outlets 30b as in the case described above. As the gas is forcibly discharged out of exhaust-side chamber 32 through outlets 30b by first and second intake and exhaust devices 10C and 20C, internal pressure of exhaust-side chamber 32 lowers. Accordingly, external gas is aggressively taken in through inlets 30a, diffuses throughout intake-side chamber 31, passes through gaps in element 50 to temperature-condition or between element 50 to temperature-condition and housing 30, and then flows into exhaust-side chamber 32. That is when element 50 is temperature-conditioned, namely, cooled or heated. Here the flow of gas is indicated as an example by outlined arrows.

Intake-side chamber 31 and exhaust-side chamber 32 may be equal or different in capacity. Above all, it is preferable as in the case described above that intake-side chamber 31 have a larger capacity than exhaust-side chamber 32. This is for the purpose of efficiently temperature-conditioning, namely, cooling or heating entire element 50.

### Fifth Exemplary Embodiment

A temperature conditioning unit according to the present exemplary embodiment includes a third intake and exhaust device, a fourth intake and exhaust device, and a housing that accommodates an element to temperature-condition. The third intake and exhaust device and the fourth intake and exhaust device have different numbers of rotor vanes.

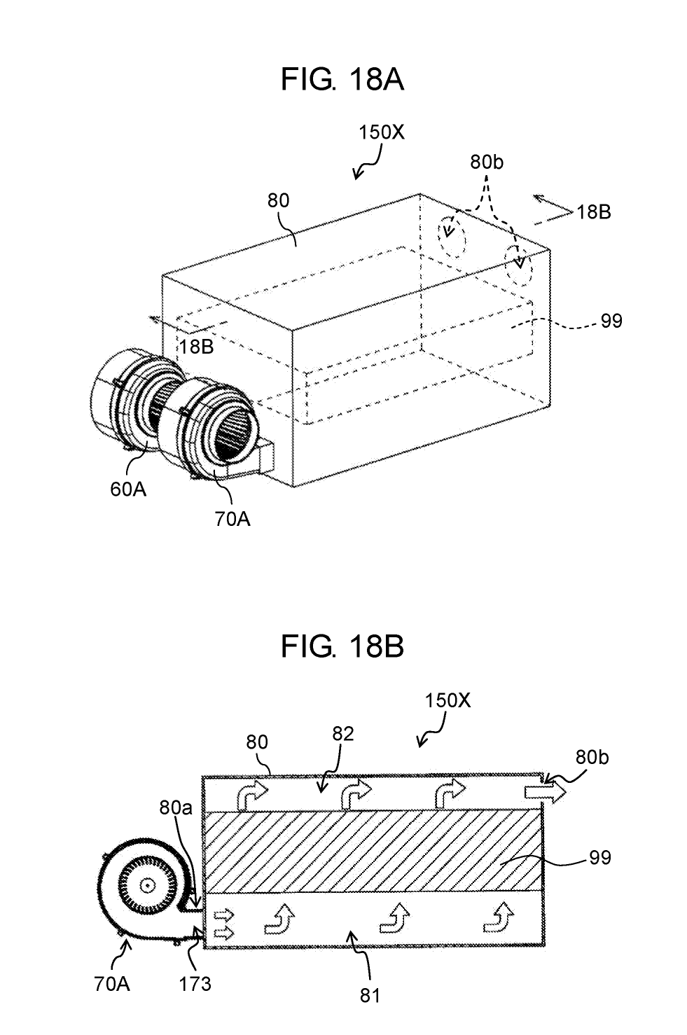

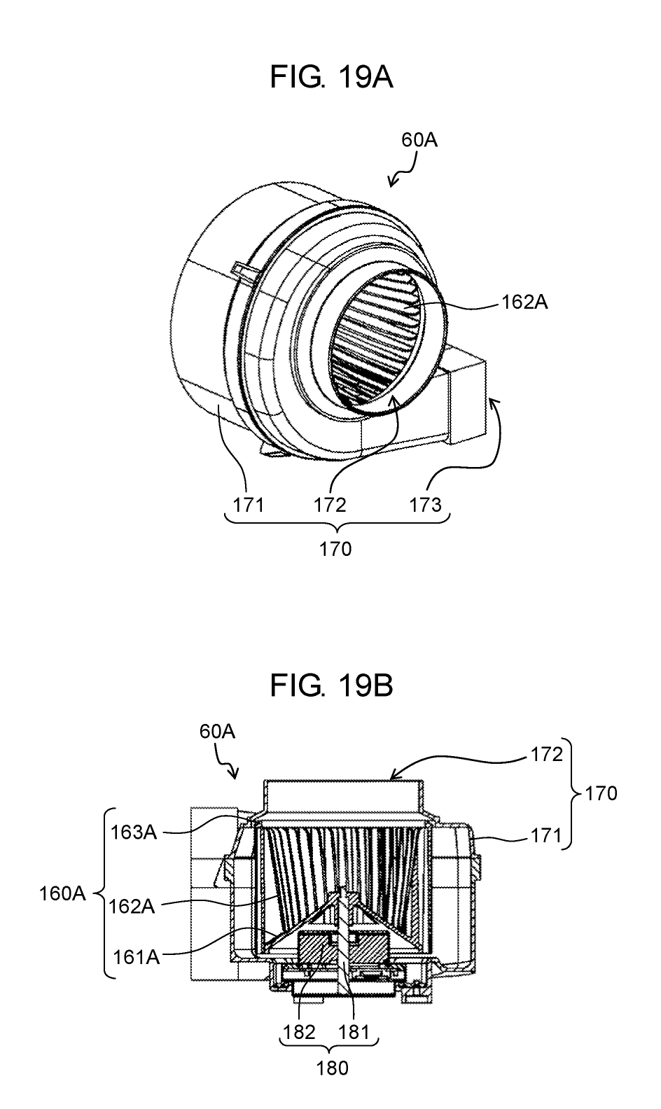

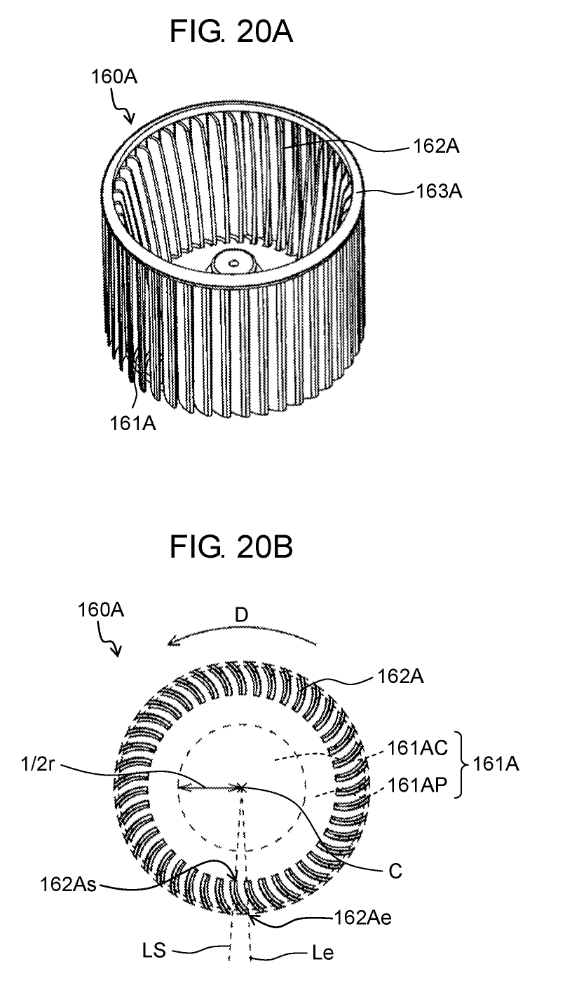

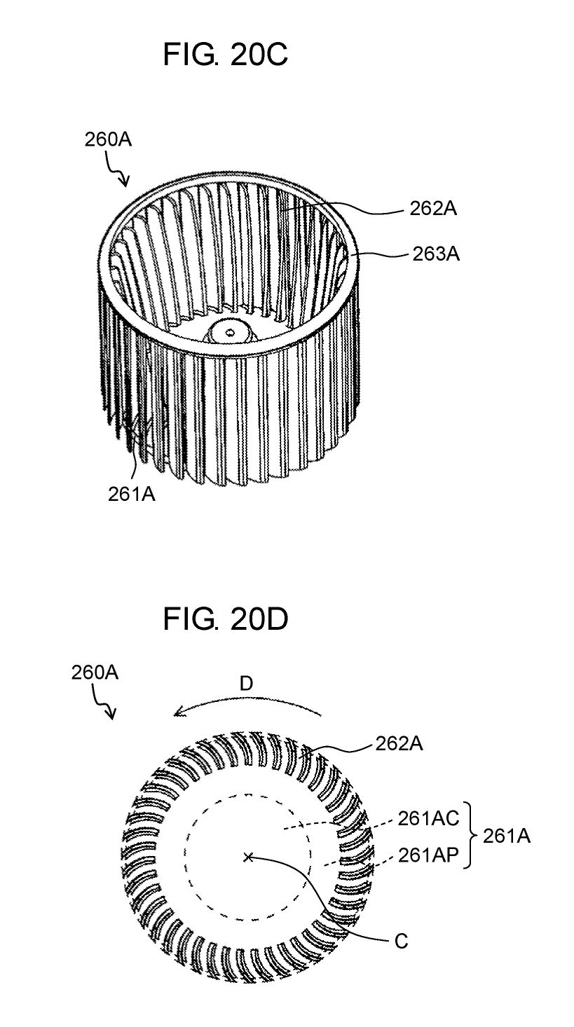

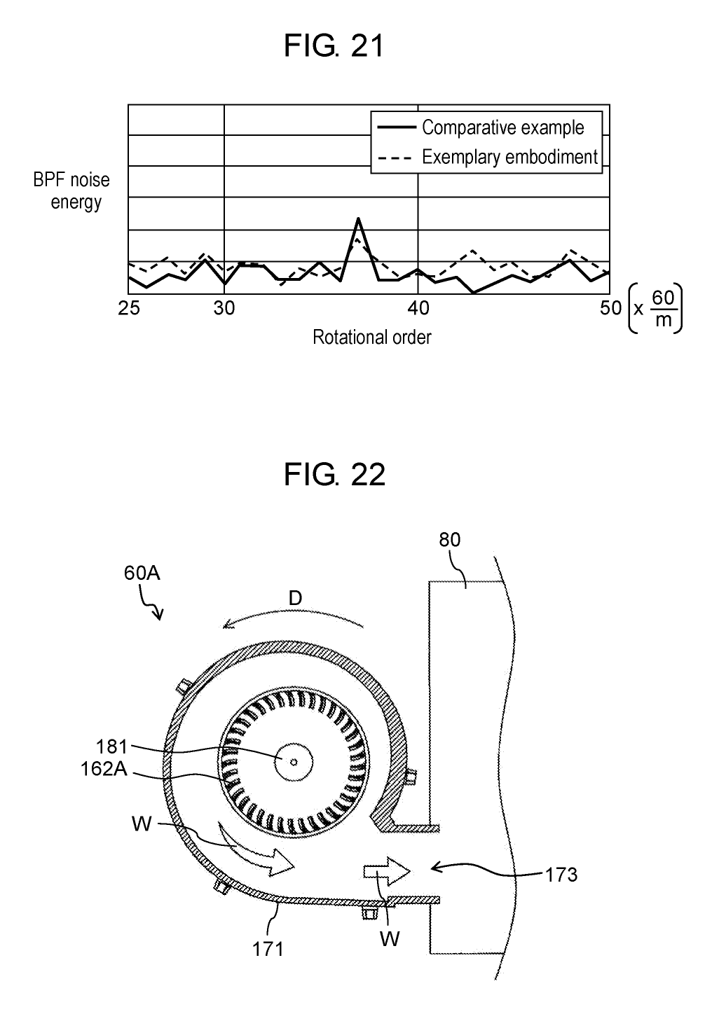

With reference to FIGS. 18A to 22, a specific description is hereinafter provided of temperature conditioning unit 150X according to the fifth exemplary embodiment. FIG. 18A is a perspective view schematically illustrating temperature conditioning unit 150X according to the fifth exemplary embodiment. FIG. 18B is a sectional view of the temperature conditioning unit, the section being taken on plane 18B-18B of FIG. 18A. FIG. 19A is a perspective view of third intake and exhaust device 60A of temperature conditioning unit 150X according to the fifth exemplary embodiment. FIG. 19B is a longitudinal section of third intake and exhaust device 60A of temperature conditioning unit 150X according to the fifth exemplary embodiment. FIG. 20A is a perspective view of impeller 160A that is disposed in third intake and exhaust device 60A of temperature conditioning unit 150X according to the fifth exemplary embodiment. FIG. 20B is a top plan view of third rotor vanes 162A that are disposed in third intake and exhaust device 60A of temperature conditioning unit 150X according to the fifth exemplary embodiment. FIG. 20C is a perspective view of impeller 260A that is disposed in fourth intake and exhaust device 70A of temperature conditioning unit 150X according to the fifth exemplary embodiment. FIG. 20D is a top plan view of fourth rotor vanes 262A that are disposed in fourth intake and exhaust device 70A of temperature conditioning unit 150X according to the fifth exemplary embodiment. In FIGS. 20B and 20D, shrouds 163A, 263A are omitted, and impeller disks 161A, 261A are indicated by broken lines. FIG. 21 is a graph showing a relationship between rotational order and energy of BPF noise produced by third and fourth intake and exhaust devices 60A and 70A of temperature conditioning unit 150X of the fifth exemplary embodiment. FIG. 22 is a sectional view of third intake and exhaust device 60A in temperature conditioning unit 150X of the fifth exemplary embodiment, as viewed from intake port 172. In the drawings, members having identical functions have the same reference marks.

### (Temperature Conditioning Unit)

As illustrated in FIGS. 18A and 18B, temperature conditioning unit 150X includes third intake and exhaust device 60A, fourth intake and exhaust device 70A, and housing 80. Housing 80 accommodates element 99 to temperature-condition. Housing 80 is provided with at least one inlet 80a where external gas is taken in and at least one outlet 80b where the gas is discharged out of housing 80.

Third intake and exhaust device 60A and fourth intake and exhaust device 70A are mounted such that their respective vents 173 face inlets 80a, respectively. This means that third intake and exhaust device 60A and fourth intake and exhaust device 70A function as blowers in the present exemplary embodiment. Inlets 80a communicate with external space, an exhaust duct (described later), or an intake duct (described later) via respective third and fourth intake and exhaust devices 60A and 70A. Also outlets 80b communicate with the external space, the exhaust duct (described later), or the intake duct (described later). Thus, the gas flows into housing 80 through third intake and exhaust device 60A and fourth intake and exhaust device 70A.

Element 99 to temperature-condition is disposed to divide an interior of housing 80 into intake-side chamber 81 including inlets 80a and exhaust-side chamber 82 including outlets 80b. The gas forcibly fed through inlets 80a by third intake and exhaust device 60A and fourth intake and exhaust device 70A diffuses throughout intake-side chamber 81, passes through gaps in element 99 to temperature-condition or between element 99 to temperature-condition and housing 80, and then flows into exhaust-side chamber 82. That is when element 99 is temperature-conditioned, namely, cooled or heated. The gas that has flowed into exhaust-side chamber 82 is discharged into the external space through outlets 80b. Here the flow of gas is indicated as an example by outlined arrows.

As illustrated in FIG. 18B, intake-side chamber 81 and exhaust-side chamber 82 may be equal or different in capacity. Above all, intake-side chamber 81 preferably has a larger capacity than exhaust-side chamber 82. Intake-side chamber 81 generally has a higher internal pressure than exhaust-side chamber 82. With the capacity of intake-side chamber 81 being larger, intake-side chamber 81 has decreased pressure resistance, thus having uniform pressure distribution. Consequently, the gas spreads throughout element 99 to temperature-condition without nonuniformity, whereby element 99 is entirely temperature-conditioned, namely, cooled or heated with efficiency.

Temperature conditioning unit 150X may have one outlet 80b or outlets 80b that are greater than or equal to 2 in number. A number of intake and exhaust devices to dispose in temperature conditioning unit 150X is not particularly limited as long as the number of intake and exhaust devices is greater than or equal to 2. Also disposition of element 99 to temperature-condition is not particularly limited. Element 99 to temperature-condition may be suitably disposed based on, for example, a use or its kind.

### (Intake and Exhaust Devices)

Third intake and exhaust device 60A is given as an example to describe structure of third intake and exhaust device 60A and structure of fourth intake and exhaust device 70A. Except for the difference in the number of rotor vanes, third intake and exhaust device 60A and fourth intake and exhaust device 70A may be structurally similar. Alternatively, in addition to the difference in the number of rotor vanes, there may be another structural difference (for example, a difference in impeller disk size) between third intake and exhaust device 60A and fourth intake and exhaust device 70A. A number of outlets (not illustrated) where the gas is discharged out of temperature conditioning unit 150X is not particularly limited and may be 1 or may be greater than or equal to 2.

### (Intake and Exhaust Devices)

As shown in FIGS. 19A and 19B, third intake and exhaust device 60A includes impeller 160A, fan case 170, and rotary drive device 180. Impeller 160A includes impeller disk 161A and the plurality of third rotor vanes 162A. Fan case 170 includes side wall 171, intake port 172, and vent 173. Rotary drive device 180 includes shaft 181 and rotary drive source 182 that rotates shaft 181.

### (Impeller)

Impeller 160A includes impeller disk 161A and the plurality of third rotor vanes 162A. Impeller 160A may also include shroud 163A.

### (Impeller Disk)

Impeller disk 161A is substantially circular and has a surface extending in a direction intersecting shaft 181. The plurality of third rotor vanes 162A are erected on one of principal surfaces of impeller disk 161A. Impeller disk 161A has an opening in a part of its central part 161AC (refer to FIG. 20B). Shaft 181 is inserted into this opening to engage impeller disk 161A. Rotary drive source 182 is rotationally driven, whereby impeller 160A rotates.

### (Shroud)

Shroud 163A is formed of a ring-shaped plate and is disposed to face impeller disk 161A via third rotor vanes 162A. When impeller 160A is viewed in an axial direction of shaft 181, an outer peripheral edge of impeller disk 161A is substantially aligned with an outer peripheral edge of shroud 163A. Here outer peripheral part 161AP (refer to FIG. 20B) of impeller disk 161A is partly covered by shroud 163A. Each of third rotor vanes 162A is partly joined to shroud 163A. The gas taken into impeller 160A flows along third rotor vanes 162A, flows out from the outer peripheral edge of impeller disk 161A, and then collides against side wall 171, thereby being guided to vent 173. Here shroud 163A suppresses outflow of the gas that has flowed out from the outer peripheral edge of impeller disk 161A from intake port 172. Shroud 163A also suppresses entry of the gas that has flowed out of an inter-vane passage formed by two adjacent third rotor vanes 162A into an adjacent inter-vane passage. To suppress a turbulent flow of gas, shroud 163A is preferably funnel-shaped or tapered having a gently curved surface that narrows toward intake port 172.

### (Rotor Vanes)

The plurality of third rotor vanes 162A are erected on impeller disk 161A. As illustrated in FIG. 20B, third rotor vanes 162A each extend in a direction from central part 161AC to outer peripheral part 161AP of impeller disk 161A in the shape of a circular arc bulging in a direction opposite to rotation direction D of shaft 181.

Similarly, the plurality of fourth rotor vanes 262A disposed in fourth intake and exhaust device 70A each extend, as illustrated in FIGS. 20C and 20D, in a direction from central part 261AC to outer peripheral part 261AP of impeller disk 261A in the shape of a circular arc bulging in a direction opposite to rotation direction D of shaft 181. Impeller 260A of fourth intake and exhaust device 70A is structurally similar to impeller 160A. Impeller 260A may also include shroud 263A.

Here number N3 of third rotor vanes 162A and number N4 of fourth rotor vanes 262A satisfy Relational Expression 7 and Relational Expression 8.

N3≠N4×n3 (where n3 is an integer greater than or equal to 1) Relational Expression 7

N3≠N4/n4 (where n4 is an integer greater than or equal to 2) Relational Expression 8

In other words, number N3 of third rotor vanes 162A is different from number N4 of fourth rotor vanes 262A, and number N3 is neither an integral multiple of number N4 nor a value obtained by division of number N4 by the integer. Accordingly, BPF noise frequency Fb3 of third intake and exhaust device 60A does not coincide with BPF noise frequency Fb4 of fourth intake and exhaust device 70A, irrespective of integer m. In this way, BPF noises are dispersed in terms of energy, and a noise is produced in suppressed condition by temperature conditioning unit 150X.

FIG. 21 is the graph showing the relationship between the rotational order and the BPF noise energy of third and fourth intake and exhaust devices 60A and 70A of temperature conditioning unit 150X of the fifth exemplary embodiment. The rotational order is obtained by division of measured frequency F by a rotational frequency (r/60) of the intake and exhaust device. Generally, BPF noise energy is greater when the rotational order is a multiple of number N of rotor vanes. A broken line in FIG. 21 indicates the BPF noise energy of the exemplary embodiment's temperature conditioning unit 150X including third intake and exhaust device 60A and fourth intake and exhaust device 70A. A solid line in FIG. 21 indicates BPF noise energy of a temperature conditioning unit of a comparative example that includes two third intake and exhaust devices 60A. In the case of the exemplary embodiment, it is shown that BPF noise energy peaks are dispersed and that BPF noise is suppressed. When respective overall values (each of which represents total energy of sounds produced by the temperature conditioning unit at all frequencies) of those temperature conditioning units were compared, the overall value was about 2% lower in the exemplary embodiment compared with the overall value of the comparative example. While FIG. 21 shows the relationship between the rotational order and the BPF noise energy when third intake and exhaust device 60A includes forty-three third rotor vanes 162A with fourth intake and exhaust device 70A including thirty-seven fourth rotor vanes 262A, a similar tendency is seen even when third intake and exhaust device 60A and fourth intake and exhaust device 70A each have the number of rotor vanes varied.

Number N3 of third rotor vanes 162A and number N4 of fourth rotor vanes 262A are not particularly limited. Number N3 of third rotor vanes 162A and number N4 of fourth rotor vanes 262A may be set appropriately in consideration of, for example, sizes of impellers 160A and 260A and respective gas volumes and respective pressures of third and fourth intake and exhaust devices 60A and 70A. Number N3 of third rotor vanes is, for example, between 25 and 50 inclusive, while number N4 of fourth rotor vanes 262A is, for example, between 30 and 45 inclusive. As long as Relational Expression 7 and Relational Expression 8 are satisfied, the difference between number N3 and number N4 is not particularly limited and may be greater than or equal to 1. When the respective gas volumes and the respective pressures of third and fourth intake and exhaust devices 60A and 70A are taken into consideration, the difference between number N3 and number N4 is preferably between 1 and 5 inclusive.

In cases where an electric motor is used as rotary drive device 180, a stator is disposed in the electric motor. The stator generally has an even number of poles. For this reason, in cases where at least one of number N3 of third rotor vanes and number N4 of fourth rotor vanes 262A is even, third rotor vanes 162A and fourth rotor vanes 262A become exciting forces, whereby rotary drive device 180, third intake and exhaust device 60A, and fourth intake and exhaust device 70A all experience vibrational excitation, and an increased noise can be caused. As such, it is preferable that number N3 of third rotor vanes 162A and number N4 of fourth rotor vanes 262A be both odd in such cases. The number of poles is a number of magnetic poles generated in rotary drive device 180. Even in cases where a number of slots of the stator corresponds to at least one of number N3 of third rotor vanes and number N4 of fourth rotor vanes 262A or even in cases where the number of slots and the at least one of number N3 and number N4 are integral multiples of each other, an increased noise can be caused. As such, each of number N3 of third rotor vanes and number N4 of fourth rotor vanes 262A is preferably set so as to neither correspond to the number of slots nor be the integral multiple of the number of slots or vice versa.

As illustrated in FIG. 20, each of third rotor vanes 162A extends in a direction from central part 161AC to outer peripheral part 161AP, starting from a point of choice as starting point 162As in outer peripheral part 161AP and ending at a point of choice as end point 162Ae in the outer peripheral part 161AP. Here third rotor vane 162A forms the circular arc bulging in the direction opposite to rotation direction D of shaft 181. When impeller disk 161A has radius r, central part 161AC of impeller disk 161A is a circle that is concentric with impeller disk 161A and has a radius of 1/2×r, while outer peripheral part 161AP of impeller disk 161A is a doughnut-shaped area surrounding central part 161AC.

From the viewpoint of suppression of a turbulent flow of gas, end point 162Ae is preferably positioned near the outer peripheral edge of impeller disk 161A. From a similar point of view, third rotor vane 162A preferably has a shorter length along the radius of impeller disk 161A. For example, starting point 162As is preferably in an area surrounded by a circle that is concentric with impeller disk 161A and has a radius of 2/3×r and the outer peripheral edge of impeller disk 161A.

The shape of third rotor vane 162A is not particularly limited as long as third rotor vane 162A includes a projecting portion. For example, when impeller disk 161A is viewed in the axial direction of shaft 181, straight line Le connecting end point 162Ae of third rotor vane 162A and center C of impeller disk 161A may be positioned ahead of straight line Ls connecting starting point 162As of third rotor vane 162A and center C of impeller disk 161A in rotation direction D.

### (Fan Case)

Fan case 170 includes side wall 171 surrounding impeller 160A, intake port 172, and vent 173 communicating with the interior of housing 80. A shape of fan case 170 is not particularly limited. Above all, fan case 170 is preferably scroll-shaped with a distance from shaft 181 to side wall 171 increasing in rotation direction D as illustrated in FIG. 22 in terms of increase in gas pressure. In this case, gas drawn in at intake port 172 flows in the axial direction of shaft 181, and gas W blown from vent 173 flows in a direction intersecting the axial direction of shaft 181.

Respective materials for the impeller disk, the rotor vane, the shroud, and the side wall are not particularly limited and may be suitably selected based on a use. Given examples of those materials include various metallic materials, various resin materials, and combinations of these materials.

### (Rotary Drive Device)

Rotary drive device 180 includes shaft 181 and rotary drive source 182 that rotates shaft 181. As shaft 181 is rotationally driven by rotary drive source 182, impeller 160A rotates, and gas is taken into fan case 170 through intake port 172.

Rotary drive device 180 is, for example, the electric motor. The electric motor is an electric appliance that outputs rotational motion through use of force of interaction between a magnetic field and an electric current (namely, Lorentz force). In the electric motor, rotary drive source 182 includes a rotor (not illustrated) and the stator (not illustrated) that produces force to rotate the rotor. Respective shapes of and respective materials for the rotor and the stator are not particularly limited, and a publicly known electric motor may be used. An output of the electric motor is not particularly limited and may be set appropriately based on, for example, a desired gas volume and a desired pressure. For example, in cases where temperature conditioning unit 150X is mounted in a hybrid vehicle, the output of the electric motor is about several tens of watts.

The stator has stator windings. When the electric current is passed through the stator winding, a magnetic field is produced around the stator winding. The magnetic field causes the rotor to rotate. A material for the stator winding is not specifically limited as long as the material is electrically conductive. Above all, the stator winding preferably includes at least one selected from the group consisting of copper, copper alloy, aluminum, and aluminum alloy in terms of low resistance.

### (Blower Controller)

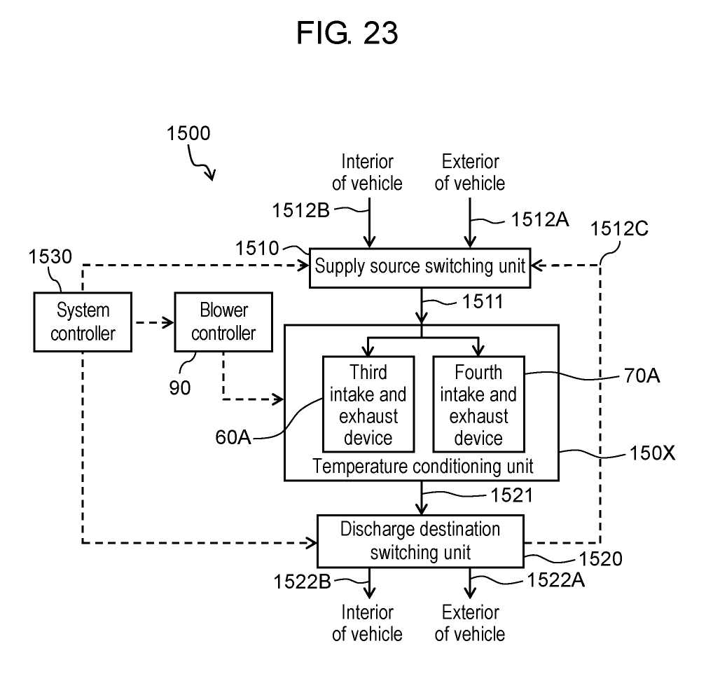

FIG. 23 is a block diagram illustrating fourth temperature conditioning system 1500 according to the fifth exemplary embodiment. Temperature conditioning unit 150X may be provided with blower controller 90 (refer to FIG. 23) that controls third intake and exhaust device 60A and fourth intake and exhaust device 70A. Blower controller 90 controls, for example, rotational speed of each of impellers 160A and 260A and an amount of gas that is supplied to each of the respective intake ports of the intake and exhaust devices.

### (Element to Temperature-Condition)

Element 99 to temperature-condition is structurally the same as element 50 to temperature-condition in the first exemplary embodiment.

### (Temperature Conditioning Systems)

A description is provided next of temperature conditioning systems.

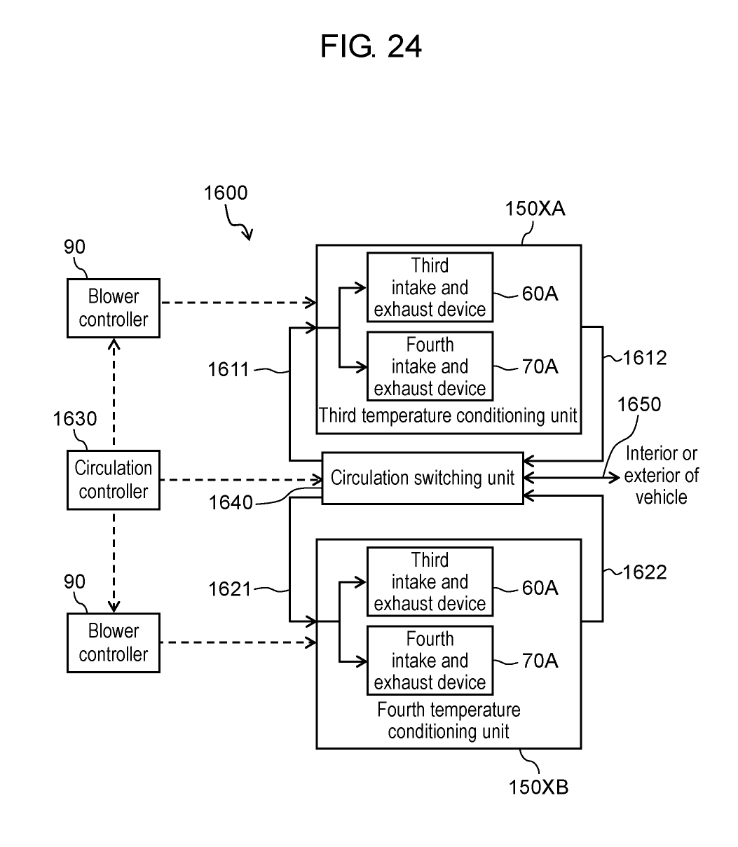

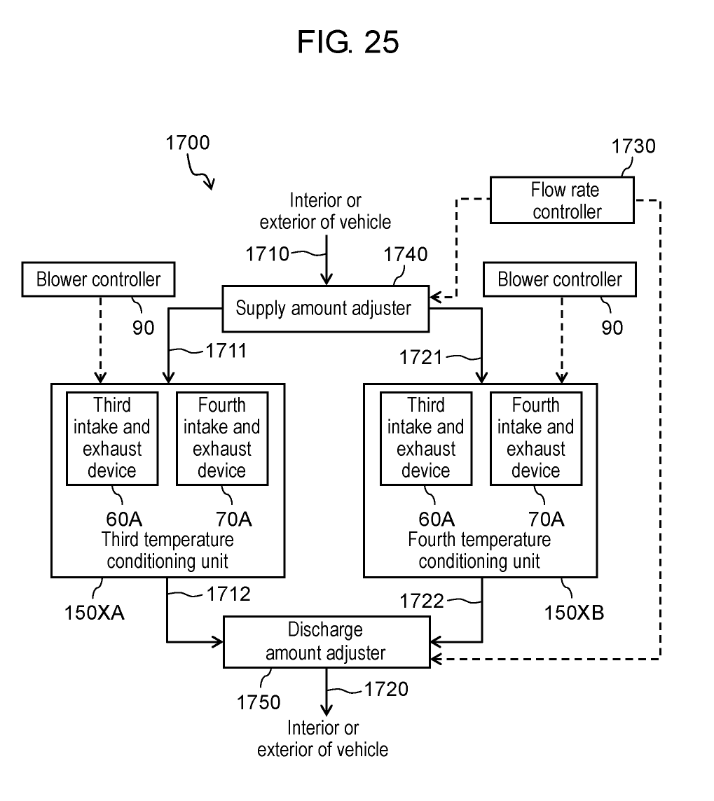

The temperature conditioning systems are each formed to include a plurality of ducts connected to temperature conditioning unit(s) 150X. With reference to FIGS. 23 to 25, the temperature conditioning systems according to the fifth exemplary embodiment are hereinafter described specifically. FIG. 23 is the block diagram illustrating fourth temperature conditioning system 1500 according to the fifth exemplary embodiment. FIG. 24 is a block diagram illustrating fifth temperature conditioning system 1600 according to the fifth exemplary embodiment. FIG. 25 is a block diagram illustrating sixth temperature conditioning system 1700 according to the fifth exemplary embodiment. In the drawings, members having identical functions have the same reference marks. In the following description, an example in which each of the temperature conditioning systems is mounted in the hybrid vehicle is given; however, the present invention is not limited to this.

### (Fourth Temperature Conditioning System)

As illustrated in FIG. 23, fourth temperature conditioning system 1500 includes, for example, intake duct 1511, a plurality of supply ducts, and system controller 1530. Intake duct 1511 connects with the respective intake ports of third intake and exhaust device 60A and fourth intake and exhaust device 70A of temperature conditioning unit 150X. The plurality of supply ducts each supply gas to intake duct 1511 and includes, in FIG. 23, fourth supply duct 1512A, fifth supply duct 1512B, and sixth supply duct 1512C. System controller 1530 controls gas supply sources for temperature conditioning unit 150X.

Intake duct 1511 connects with supply ducts 1512A to 1512C via supply source switching unit 1510. Fourth supply duct 1512A has one end connecting with an exterior of the vehicle and another end connecting with supply source switching unit 1510. Fifth supply duct 1512B has one end connecting with an interior of the vehicle and another end connecting with supply source switching unit 1510. Sixth supply duct 1512C has one end connecting with discharge destination switching unit 1520 that is described later and another end connecting with supply source switching unit 1510. It is to be noted that the one end of sixth supply duct 1512C may connect directly with the outlets (not illustrated) of temperature conditioning unit 150X.

Supply source switching unit 1510 is controlled by system controller 1530. Supply source switching unit 1510 opens or closes parts of connection with supply ducts 1512A to 1512C to effect switching(s) among the gas supply sources for temperature conditioning unit 150X. The gas supplied from any one of supply ducts 1512A to 1512C passes through intake duct 1511 and is taken into the impellers through the respective intake ports of third and fourth intake and exhaust devices 60A and 70A. The amount of gas supply for each of third and fourth intake and exhaust devices 60A and 70A is controlled by blower controller 90. System controller 1530 controls the gas supply sources for temperature conditioning unit 150X. System controller 1530 may control a flow rate of gas that is supplied to intake duct 1511. Moreover, system controller 1530 may control blower controller 90.

In cases where a temperature outside the vehicle is a temperature (hereinafter “cooling temperature”) suitable for cooling of element 99 to temperature-condition, supply source switching unit 1510 opens the part of connection with fourth supply duct 1512A to supply gas from outside the vehicle to temperature conditioning unit 150X. In cases where a temperature of the vehicle's interior is a temperature (hereinafter “heating temperature”) that is suited to raise the cooling temperature or to heat element 99 to temperature-condition, supply source switching unit 1510 opens the part of connection with fifth supply duct 1512B to supply gas from the interior of the vehicle to temperature conditioning unit 150X. In cases where exhaust gas from temperature conditioning unit 150X has a cooling temperature or a heating temperature, supply source switching unit 1510 may open the part of connection with sixth supply duct 1512C to supply the exhaust gas to temperature conditioning unit 150X.

Fourth temperature conditioning system 1500 also includes discharge duct 1521 connecting with the outlets of temperature conditioning unit 150X, exhaust duct 1522A that lets the gas out of the vehicle, and exhaust duct 1522B that discharges the gas into the interior of the vehicle. Discharge duct 1521 connects with exhaust duct 1522A and exhaust duct 1522B via discharge destination switching unit 1520. Exhaust duct 1522A has one end connecting with the exterior of the vehicle and another end connecting with discharge destination switching unit 1520. Exhaust duct 1522B has one end connecting with the interior of the vehicle and another end connecting with discharge destination switching unit 1520. As described above, discharge destination switching unit 1520 also connects with the other end of sixth supply duct 1512C.

Also discharge destination switching unit 1520 is controlled by system controller 1530. Discharge destination switching unit 1520 opens or closes parts of connection with exhaust duct 1522A, exhaust duct 1522B, and sixth supply duct 1512C to effect switching(s) among discharge destinations for the gas from temperature conditioning unit 150X. System controller 1530 changes the discharge destination(s) of the gas from temperature conditioning unit 150X and may control a flow rate of gas that is discharged into discharge duct 1521.

Discharged gas generally has a higher temperature than gas that is drawn in. As such, when the interior (particularly an internal cabin space) of the vehicle has a lower temperature, discharge destination switching unit 1520 preferably opens the part of connection with exhaust duct 1522B. In this way, the warmer gas is discharged into the vehicle's interior, and the vehicle's interior can be warmed up accordingly. In cases where the temperature of the vehicle's interior is high enough, discharge destination switching unit 1520 opens the part of connection with exhaust duct 1522A to let the gas out of the vehicle.

Thus, in fourth temperature conditioning system 1500, the gas supply source(s) for element 99 to temperature-condition and the discharge destination(s) of gas discharged from element 99 to temperature-condition can be changed based on the temperature outside the vehicle, the temperature of the vehicle's interior, and the temperature of the gas discharged from temperature conditioning unit 150X. In other words, according to fourth temperature conditioning system 1500, the gas from outside the vehicle or from the vehicle's interior is taken in, or the gas is discharged into the vehicle's interior. In this way, element 99 can be temperature-conditioned while energy is effectively utilized. Moreover, with gas taken in from outside the vehicle or from a closed space in the vehicle or with gas discharged out of the vehicle or into the closed space in the vehicle, gas quantity is equalized between intake and discharge, thus enabling suppression of pressure changes in the vehicle's interior.

### (Fifth Temperature Conditioning System)

There are also cases where a plurality of temperature conditioning units 150X are disposed in the hybrid vehicle. In such cases, from the viewpoint of effective energy utilization, respective gas courses of temperature conditioning units 150X may be connected to each other to achieve a gas circulation system. This facilitates equalization of gas quantity between intake and discharge, thus leading to suppression of pressure changes in the interior of the vehicle.

As illustrated in FIG. 24, fifth temperature conditioning system 1600 that allows gas circulation between the plurality of temperature conditioning units 150X includes, for example, third temperature conditioning unit 150XA, fourth temperature conditioning unit 150XB, intake duct 1611, exhaust duct 1612, intake duct 1621, exhaust duct 1622, and circulation controller 1630. Intake duct 1611 connects with the respective intake ports of third intake and exhaust device 60A and fourth intake and exhaust device 70A of third temperature conditioning unit 150XA. Exhaust duct 1612 lets gas out from the outlets of third temperature conditioning unit 150XA. Intake duct 1621 connects with the respective intake ports of third intake and exhaust device 60A and fourth intake and exhaust device 70A of fourth temperature conditioning unit 150XB. Exhaust duct 1622 lets gas out from the outlets of fourth temperature conditioning unit 150XB. From exhaust duct 1612 and exhaust duct 1622, circulation controller 1630 determines exhaust duct(s) for connection to at least one of intake duct 1611 and intake duct 1621.

Intake duct 1611, intake duct 1621, exhaust duct 1612, and exhaust duct 1622 are interconnected via circulation switching unit 1640. In other words, intake duct 1611 has one end connecting with the intake ports of first temperature conditioning unit 150XA and another end connecting with circulation switching unit 1640. Exhaust duct 1612 has one end connecting with the outlets of third temperature conditioning unit 150XA and another end connecting with circulation switching unit 1640. Intake duct 1621 has one end connecting with the intake ports of fourth temperature conditioning unit 150XB and another end connecting with circulation switching unit 1640. Exhaust duct 1622 has one end connecting with the outlets of fourth temperature conditioning unit 150XB and another end connecting with circulation switching unit 1640. Circulation switching unit 1640 may also connect with one end of duct 1650. Another end of duct 1650 connects with, for example, the exterior or the interior of the vehicle. Duct 1650 takes in gas from outside the vehicle or from the vehicle's interior or discharges the gas out of the vehicle or into the vehicle's interior when necessary.

Circulation switching unit 1640 is controlled by circulation controller 1630. From exhaust duct 1612 and exhaust duct 1622, circulation controller 1630 determines exhaust duct(s) for connection to at least one of intake duct 1611 and intake duct 1621. Based on this determination, circulation switching unit 1640 opens or closes parts of connection with intake duct 1611, intake duct 1621, exhaust duct 1612, and exhaust duct 1622 to effect switching(s) among gas supply sources or gas discharge destinations for third temperature conditioning unit 150XA and fourth temperature conditioning unit 150XB. Circulation controller 1630 may also control a flow rate of gas in each of the ducts. The amount of gas supply for each of the intake and exhaust devices of each of the temperature conditioning units is controlled by corresponding blower controller 90. Circulation controller 1630 may also control blower controllers 90.

With fifth temperature conditioning system 1600, elements 99 can be temperature-conditioned while energy is effectively utilized through gas circulation between the plurality of temperature conditioning units. Such a system is useful in cases where gas discharged from third temperature conditioning unit 150XA or fourth temperature conditioning unit 150XB has a suitable temperature for cooling or heating of element 99 to temperature-condition. While fifth temperature conditioning system 1600 has two temperature conditioning units 150XA and 150XB in the illustrated example, it is to be noted that this is not limiting. Fifth temperature conditioning system 1600 may, for example, include one temperature conditioning unit 150XA or 150XB and another temperature conditioning unit (such as the one that includes one intake and exhaust device). The temperature conditioning units of fifth temperature conditioning system 1600 may be greater than or equal to three in number with gas circulated at least between two of those temperature conditioning units. While third and fourth temperature conditioning units 150XA and 150XB each have two intake and exhaust devices 60A and 70B in the illustrated example, this is not limiting. Each of third and fourth temperature conditioning units 150XA and 150XB may, for example, include intake and exhaust devices that are greater than or equal to three in number. Third and fourth temperature conditioning units 150XA and 150XB may have the same intake and exhaust devices disposed or different intake and exhaust devices disposed. The same goes for a sixth temperature conditioning system that is described later.

### (Sixth Temperature Conditioning System)

In cases where a plurality of temperature conditioning units 150X are disposed, temperature conditioning units 150X may be connected in parallel for collective quantitative control of gases that are respectively drawn into temperature conditioning units 150X. This enables effective energy utilization.

As illustrated in FIG. 25, sixth temperature conditioning system 1700 having the plurality of temperature conditioning units 150X connected in parallel includes, for example, third temperature conditioning unit 150XA, fourth temperature conditioning unit 150XB, intake duct 1711, intake duct 1721, intake connection duct 1710, and flow rate controller 1730. Intake duct 1711 connects with the respective intake ports of third intake and exhaust device 60A and fourth intake and exhaust device 70A of third temperature conditioning unit 150XA. Intake duct 1721 connects with the respective intake ports of third intake and exhaust device 60A and fourth intake and exhaust device 70A of second temperature conditioning unit 150XB. Intake connection duct 1710 branches off to connect with intake duct 1711 and intake duct 1721. Flow rate controller 1730 controls a flow rate of gas in intake duct 1711 and a flow rate of gas in intake duct 1721.

Intake connection duct 1710 connects with intake duct 1711 and intake duct 1721 via supply amount adjuster 1740. Intake connection duct 1710 connects with, for example, the exterior or the interior of the vehicle. Supply amount adjuster 1740 is controlled by flow rate controller 1730. Supply amount adjuster 1740 opens or closes parts of connection with intake duct 1711 and intake duct 1721 to adjust an amount of gas supply for third temperature conditioning unit 150XA and an amount of gas supply for fourth temperature conditioning unit 150XB. The amount of gas supply for each of third and fourth intake and exhaust devices 60A and 70A of each of the temperature conditioning units is controlled by corresponding blower controller 90. Flow rate controller 1730 may also control blower controllers 90.

Sixth temperature conditioning system 1700 may also include exhaust duct 1712, exhaust duct 1722, and exhaust connection duct 1720. Exhaust duct 1712 connects with the outlets of third temperature conditioning unit 150XA. Exhaust duct 1722 connects with the outlets of fourth temperature conditioning unit 150XB. Exhaust connection duct 1720 connects with exhaust duct 1712 and exhaust duct 1722.

Exhaust connection duct 1720 connects with exhaust duct 1712 and exhaust duct 1722 via discharge amount adjuster 1750. Exhaust connection duct 1720 connects with, for example, the exterior or the interior of the vehicle. Discharge amount adjuster 1750 is controlled by flow rate controller 1730. Discharge amount adjuster 1750 opens or closes parts of connection with exhaust duct 1712 and exhaust duct 1722 to adjust an amount of gas discharge from third temperature conditioning unit 150XA and an amount of gas discharge from fourth temperature conditioning unit 150XB.

With sixth temperature conditioning system 1700, elements 99 can be temperature-conditioned while energy is effectively utilized through collective quantitative control of gases that are respectively drawn into the plurality of temperature conditioning units (third and fourth temperature conditioning units 150XA and 150XB in FIG. 25).

### (Vehicles)

Temperature conditioning unit 150X, temperature conditioning system 1500, temperature conditioning system 1600, or temperature conditioning system 1700 is mounted, for example, in vehicles including the hybrid vehicle.

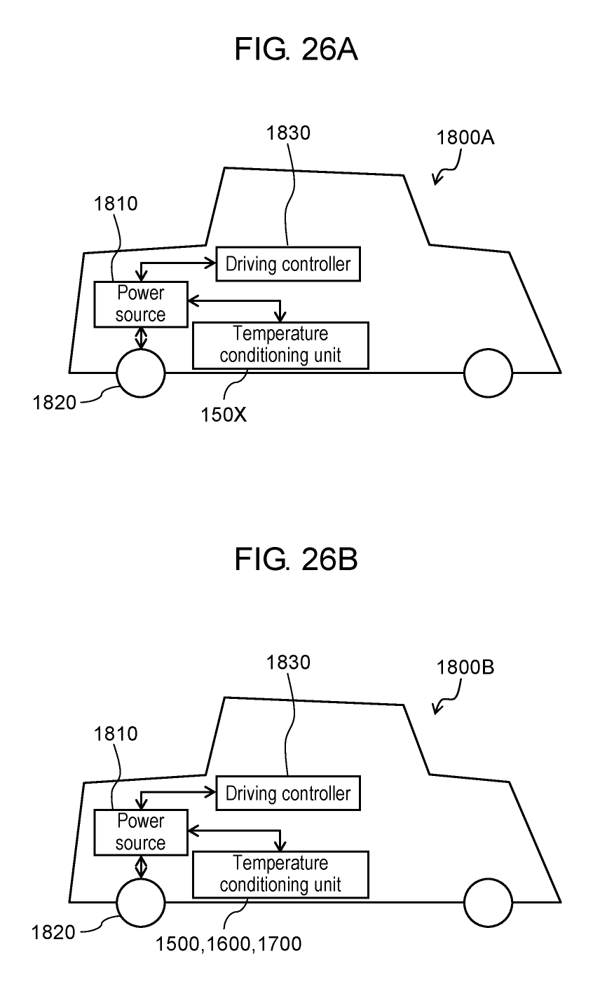

FIG. 26A is a schematic view of vehicle 1800A according to the fifth exemplary embodiment. Vehicle 1800A includes power source 1810, drive wheels 1820, driving controller 1830, and temperature conditioning unit 150X. Power source 1810 supplies power to drive wheels 1820. Driving controller 1830 controls power source 1810.

FIG. 26B is a schematic view of another vehicle 1800B according to the fifth exemplary embodiment. Vehicle 1800B includes power source 1810, drive wheels 1820, driving controller 1830, and temperature conditioning system 1500, 1600, or 1700. Vehicles 1800A and 1800B can allow secondary batteries and others to function at suitable temperatures with noises suppressed, thus each offering excellent comfort and high performance.

### Sixth Exemplary Embodiment

The present exemplary embodiment differs from the fifth exemplary embodiment in that a plurality of intake and exhaust devices to use have the same number N of rotor vanes disposed and that an impeller of at least one of the intake and exhaust devices (a third intake and exhaust device) and an impeller of another intake and exhaust device (a fourth intake and exhaust device) rotate at different rotational speeds r. A temperature conditioning unit, temperature conditioning systems, and vehicles are otherwise similar to those in the fifth exemplary embodiment. With the impellers varying in rotational speed r, BPF noise frequency Fb3 of the third intake and exhaust device does not coincide with BPF noise frequency Fb4 of the fourth intake and exhaust device. In this way, the BPF noise peaks are dispersed, and a noise is produced in suppressed condition by the temperature conditioning unit.

Variations in rotational speed r result in variations in gas volume obtained. When cooling efficiency and ease of control are taken into account, it is preferable that a plurality of intake and exhaust devices disposed in one temperature conditioning system be comparable in gas volume. To achieve comparable gas volumes with variations in rotational speed r, maximum diameter L3 of an impeller disk of the third intake and exhaust device and maximum diameter L4 of an impeller disk of the fourth intake and exhaust device are varied in the present exemplary embodiment when these impeller disks are each viewed in an axial direction of a shaft. The impeller having the smaller impeller disk is rotated at a higher speed than the other impeller is rotated, thereby being adjusted to a comparable gas volume.

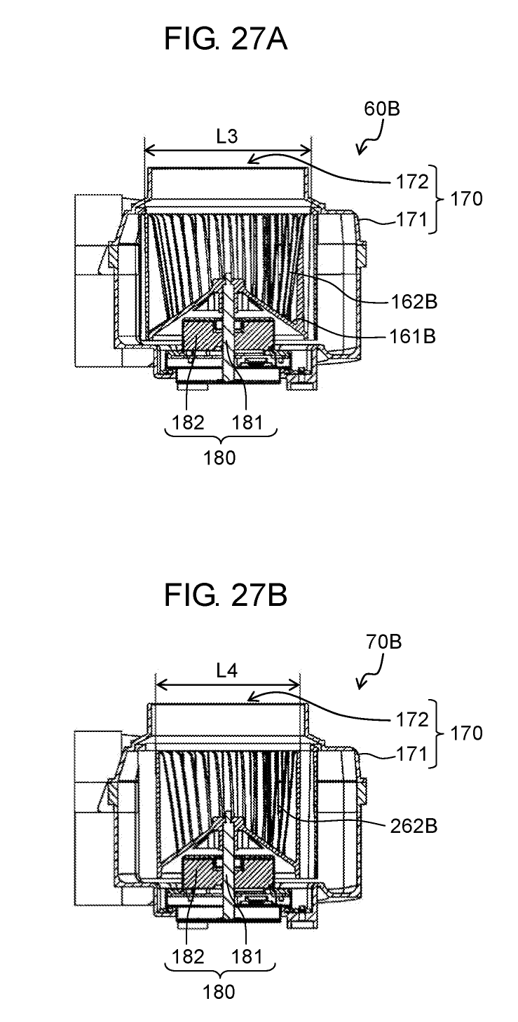

With reference to FIGS. 27A and 27B, a description is provided of the intake and exhaust devices according to the present exemplary embodiment. FIG. 27A is a longitudinal section of third intake and exhaust device 60B according to the sixth exemplary embodiment. FIG. 27B is a longitudinal section of fourth intake and exhaust device 70B according to the sixth exemplary embodiment. Third intake and exhaust device 60B and fourth intake and exhaust device 70B may be structurally similar, except that impeller disk 161B has the different maximum diameter when viewed in the axial direction of the shaft. This means that third rotor vanes 162B of third intake and exhaust device 60B are the same in number as fourth rotor vanes 262B of fourth intake and exhaust device 70B. Moreover, fan case 170 of third intake and exhaust device 60B has the same outside diameter as fan case 170 of fourth intake and exhaust device 70B. Third intake and exhaust device 60B and fourth intake and exhaust device 70B are not structurally limited to this, but may differ in the number of rotor vanes disposed or may have fan cases 170 of different outside diameters. In FIGS. 27A and 27B, third intake and exhaust device 60B and fourth intake and exhaust device 70B are structurally similar to third intake and exhaust device 60A but are not limited to this. It is to be noted that FIGS. 27A and 27B show that maximum diameter L3>maximum diameter L4.

L3/L4, which is a ratio of maximum diameter L3 to maximum diameter L4, is not particularly limited and may be determined appropriately in consideration of, for example, desired gas volumes and desired rotational speeds of the intake and exhaust devices. In the case of L3>L4, L3/L4 is, for example, greater than 1 and less than or equal to 1.7 and is preferably greater than 1 and less than or equal to 1.4. In the above cases, an operating point of a rotary drive source of third intake and exhaust device 60B and an operating point of a rotary drive source of fourth intake and exhaust device 70B do not have to be varied largely. For this reason, rotary drive sources 182 of the same type can be used in third intake and exhaust device 60B and fourth intake and exhaust device 70B, respectively. The operating point of the rotary drive source is a point of intersection of a speed characteristic curve that shows a rotational speed with respect to an electric current and a torque characteristic curve that shows torque with respect to the electric current.

### Seventh Exemplary Embodiment

Temperature conditioning unit 150Y according to the present exemplary embodiment is similar to the temperature conditioning unit of the fifth or sixth exemplary embodiment and is also similar to those in the temperature conditioning systems and the vehicles of the fifth or sixth exemplary embodiment, except that respective intake ports 172 of the third and fourth intake and exhaust devices are mounted to face outlets 80b, respectively. It is to be noted that in each of temperature conditioning systems, the intake duct and the exhaust duct, for example, are appropriately replaced before connection to temperature conditioning unit 150Y. In this way, internal gas of housing 80 is discharged through the intake and exhaust devices. This means that the intake and exhaust devices function as dischargers in the present exemplary embodiment.

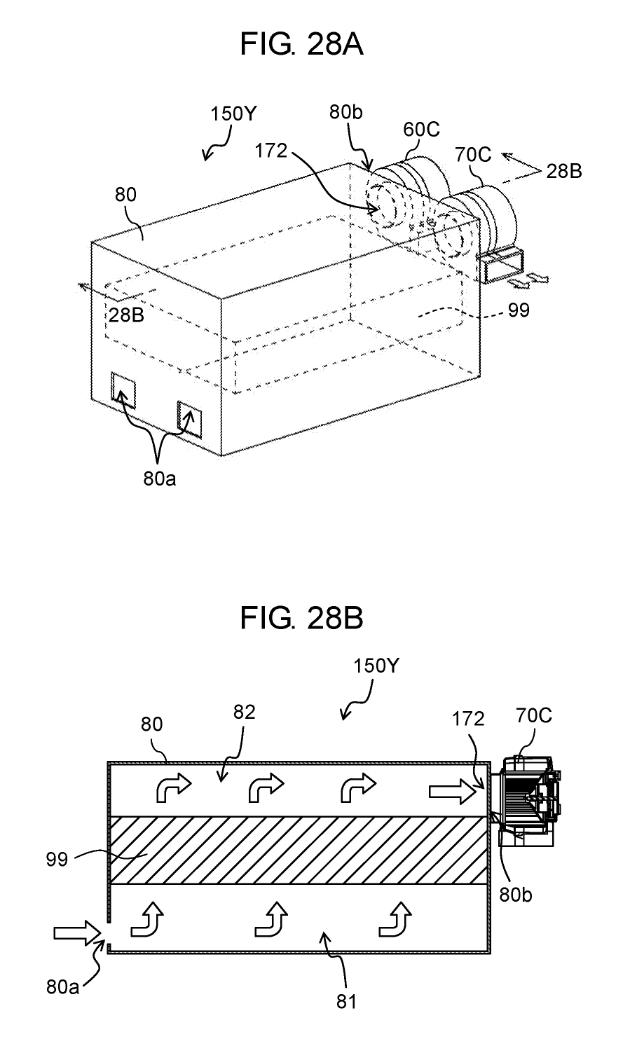

With reference to FIGS. 28A and 28B, a specific description is hereinafter provided of temperature conditioning unit 150Y according to the present exemplary embodiment. FIG. 28A is a perspective view schematically illustrating temperature conditioning unit 150Y according to the seventh exemplary embodiment. FIG. 28B is a sectional view of temperature conditioning unit 150Y, the section being taken on plane 28B-28B of FIG. 28A. It is to be noted that an internal structure of each of the intake and exhaust devices is omitted in FIG. 28A. Third intake and exhaust device 60C is structurally similar to above-described third intake and exhaust device 60A or above-described third intake and exhaust device 60B, and fourth intake and exhaust device 70C is structurally similar to above-described fourth intake and exhaust device 70A or above-described fourth intake and exhaust device 70B. It is to be noted that temperature conditioning unit 150Y is not limited to the above structure. For example, orientation of each of vents 173 is not particularly limited and may be set appropriately to be right for a use or for the duct that is connected to vent 173. Alternatively, vent 173 may be connected to the duct via a coupling member (not illustrated) such as an L-shaped elbow pipe. In this case, vent 173 is oriented appropriately to be right for the coupling member.

Element 99 to temperature-condition is disposed, for example, to divide the interior of housing 80 into intake-side chamber 81 including inlets 80a and exhaust-side chamber 82 including outlets 80b as in the case described above. As the gas is forcibly discharged out of exhaust-side chamber 82 through outlets 80b by third and fourth intake and exhaust devices 60A and 60B, internal pressure of exhaust-side chamber 82 lowers. Accordingly, external gas is aggressively taken in through inlets 80a, diffuses throughout intake-side chamber 81, passes through gaps in element 99 to temperature-condition or between element 99 to temperature-condition and housing 80, and then flows into exhaust-side chamber 82. That is when element 99 is temperature-conditioned, namely, cooled or heated. Here the flow of gas is indicated as an example by outlined arrows.

Intake-side chamber 81 and exhaust-side chamber 82 may be equal or different in capacity. Above all, it is preferable as in the case described above that intake-side chamber 81 have a larger capacity than exhaust-side chamber 82. This is for the purpose of efficiently temperature-conditioning, namely, cooling or heating entire element 99.

### INDUSTRIAL APPLICABILITY

A temperature conditioning unit according to the present invention produces a lower level of noise while including a plurality of intake and exhaust devices and thus is useful to vehicles in particular.

### REFERENCE MARKS IN THE DRAWINGS

10A, 10B, 10C first intake and exhaust device

20A, 20B, 20C second intake and exhaust device

30 housing

30a inlet

30b outlet

31 intake-side chamber

32 exhaust-side chamber

40 blower controller

50 element to temperature-condition

60A, 60B, 60C third intake and exhaust device

70A, 70B, 70C fourth intake and exhaust device

80 housing

80a inlet

80b outlet

81 intake-side chamber

82 exhaust-side chamber

90 blower controller

99 element to temperature-condition

100X, 100Y temperature conditioning unit

100XA first temperature conditioning unit

100XB second temperature conditioning unit

110A impeller

111A, 111B impeller disk

111AC central part

111AP outer peripheral part

112A, 112B first rotor vane

112As starting point

112Ae end point

113A shroud

120 fan case

121 side wall

121S shoulder

122 intake port

123 vent

130 rotary drive device

131 shaft

132 rotary drive source

141 stator vane

142 diffuser ring

150X, 150Y temperature conditioning unit

150XA third temperature conditioning unit

150XB fourth temperature conditioning unit

160A impeller

161A, 161B impeller disk

161AC central part

161AP outer peripheral part

162A, 162B third rotor vane

162As starting point

162Ae end point

163A shroud

170 fan case

171 side wall

172 intake port

173 vent

180 rotary drive device

181 shaft

182 rotary drive source

210A impeller

211A impeller disk

211AC central part

211AP outer peripheral part

212A, 212B second rotor vane

213A shroud

260A impeller

261A impeller disk

261AC central part

261AP outer peripheral part

262A, 262B fourth rotor vane

263A shroud

500 first temperature conditioning system

510 supply source switching unit

511 intake duct

512A first supply duct

512B second supply duct

512C third supply duct

520 discharge destination switching unit

521 discharge duct

522A exhaust duct

522B exhaust duct

530 system controller

600 second temperature conditioning system

611 intake duct

612 exhaust duct

621 intake duct

622 exhaust duct

630 circulation controller

640 circulation switching unit

650 duct

700 third temperature conditioning system

710 intake connection duct

711 intake duct

721 intake duct

720 exhaust connection duct

712 exhaust duct

722 exhaust duct

730 flow rate controller

740 supply amount adjuster

750 discharge amount adjuster

800A, 800B vehicle

810 power source

820 drive wheel

830 driving controller

911 impeller disk

912 forward swept vane

912e end point

1500 fourth temperature conditioning system

1510 supply source switching unit

1511 intake duct

1512A fourth supply duct

1512B fifth supply duct

1512C sixth supply duct

1520 discharge destination switching unit

1521 discharge duct

1522A exhaust duct

1522B exhaust duct

1530 system controller

1600 fifth temperature conditioning system

1611 intake duct

1612 exhaust duct

1621 intake duct

1622 exhaust duct

1630 circulation controller

1640 circulation switching unit

1650 duct

1700 sixth temperature conditioning system

1710 intake connection duct

1711 intake duct

1721 intake duct

1720 exhaust connection duct

1712 exhaust duct

1722 exhaust duct

1730 flow rate controller

1740 supply amount adjuster

1750 discharge amount adjuster

1800A, 1800B vehicle

1810 power source

1820 drive wheel

1830 driving controller

1. A temperature conditioning unit comprising:
a first intake and exhaust device;
a second intake and exhaust device; and
a housing that accommodates an element to temperature-condition, wherein
the first intake and exhaust device and the second intake and exhaust device each include:
a rotary drive device including a shaft and a rotary drive source that rotates the shaft;
an impeller including an impeller disk and a plurality of rotor vanes erected on the impeller disk, the impeller disk engaging the shaft at a central part of the impeller disk and including a surface extending in a direction intersecting the shaft; and
a fan case including a side wall, an intake port, and a vent, the side wall surrounding the impeller, the vent communicating with an interior of the housing,
the plurality of rotor vanes each extend in a direction from the central part to an outer peripheral part of the impeller disk in a shape of a circular arc bulging in a rotation direction of the shaft, and
a frequency at which the first intake and exhaust device produces a sound having an energy peak is different from a frequency at which the second intake and exhaust device produces a sound having an energy peak.

2. The temperature conditioning unit according to claim 1, wherein the intake port and the vent are disposed to face each other in an axial direction of the shaft.

3. The temperature conditioning unit according to claim 1, wherein a number N1 of the rotor vanes of the first intake and exhaust device and a number N2 of the rotor vanes of the second intake and exhaust device satisfy a relationship, N1≠N2×n1, and a relationship, N1≠N2/n2, where n1 is an integer greater than or equal to 1, and n2 is an integer greater than or equal to 2.

4. The temperature conditioning unit according to claim 1, wherein a maximum diameter of the impeller disk of the first intake and exhaust device is different from a maximum diameter of the impeller disk of the second intake and exhaust device when the impeller disks are each viewed in an axial direction of the shaft.

5. The temperature conditioning unit according to claim 1, wherein at least one of the first intake and exhaust device and the second intake and exhaust device further includes a plurality of stator vanes disposed between the side wall of the fan case and the rotor vanes.

6. The temperature conditioning unit according to claim 5, wherein
the first intake and exhaust device includes the plurality of stator vanes, and
a number N1 of the rotor vanes of the first intake and exhaust device and a number Nd1 of the stator vanes of the first intake and exhaust device satisfy a relationship, N1≠Nd1×n3, and a relationship, N1≠Nd1/n4, where n3 is an integer greater than or equal to 1, and n4 is an integer greater than or equal to 2.

7. The temperature conditioning unit according to claim 5, wherein
the second intake and exhaust device includes the plurality of stator vanes, and
a number N2 of the rotor vanes of the second intake and exhaust device and a number Nd2 of the stator vanes of the second intake and exhaust device satisfy a relationship, N2≠Nd2×n5, and a relationship, N2≠Nd2/n6, where n5 is an integer greater than or equal to 1, and n6 is an integer greater than or equal to 2.

8. The temperature conditioning unit according to claim 1, further comprising a blower controller that controls the first intake and exhaust device and the second intake and exhaust device.

9. The temperature conditioning unit according to claim 1, wherein the element to temperature-condition is a secondary battery.

10. The temperature conditioning unit according to claim 1, wherein the element to temperature-condition is a power converter.

11. The temperature conditioning unit according to claim 1, wherein at least one of the rotary drive device of the first intake and exhaust device and the rotary drive device of the second intake and exhaust device is an electric motor.

12. The temperature conditioning unit according to claim 11, wherein a stator winding of the electric motor includes at least one selected from a group consisting of copper, copper alloy, aluminum, and aluminum alloy.

13. A temperature conditioning system comprising:
the temperature conditioning unit according to claim 1;
an intake duct connecting with the intake port of the first intake and exhaust device and the intake port of the second intake and exhaust device;
a plurality of supply ducts that supply gas to the intake duct; and
a system controller that selects one or more from among the plurality of supply ducts to effect supply of the gas to the intake duct.

14. A temperature conditioning system comprising:
a first temperature conditioning unit being the temperature conditioning unit according to claim 1;
a second temperature conditioning unit being the temperature conditioning unit according to claim 1;
a first intake duct connecting with the respective intake ports of the first intake and exhaust device and the second intake and exhaust device of the first temperature conditioning unit;
a first exhaust duct that lets gas out from an outlet of the first temperature conditioning unit;
a second intake duct connecting with the respective intake ports of the first intake and exhaust device and the second intake and exhaust device of the second temperature conditioning unit;
a second exhaust duct that lets gas out from an outlet of the second temperature conditioning unit; and
a circulation controller that selects at least one of the first exhaust duct and the second exhaust duct to effect supply of the gas to at least one of the first intake duct and the second intake duct.

15. A temperature conditioning system comprising:
a first temperature conditioning unit being the temperature conditioning unit according to claim 1;
a second temperature conditioning unit being the temperature conditioning unit according to claim 1;
a first intake duct connecting with the respective intake ports of the first intake and exhaust device and the second intake and exhaust device of the first temperature conditioning unit;
a second intake duct connecting with the respective intake ports of the first intake and exhaust device and the second intake and exhaust device of the second temperature conditioning unit;
a connection duct branching off and connecting with the first intake duct and the second intake duct; and
a flow rate controller that controls a flow rate of gas in the first intake duct and a flow rate of gas in the second intake duct.

16. A vehicle mounted with the temperature conditioning unit according to claim 1.

17. A vehicle mounted with the temperature conditioning system according to claim 13.

18. A vehicle mounted with the temperature conditioning system according to claim 14.

19. A vehicle mounted with the temperature conditioning system according to claim 15.

20. The temperature conditioning unit according to claim 1, wherein a distance from the shaft to the side wall of the fan case increases in the rotation direction of the shaft.

21. The temperature conditioning unit according to claim 20, wherein gas drawn in at the intake port flows in a direction along the shaft, and gas blown from the vent flows in a direction intersecting the shaft.
